(19) United States
(12) Patent Application Publication
(10) Pub. No.: US 2023/0224096 A1
(43) Pub. Date: Jul. 13, 2023

(54) SIDELINK COMMUNICATION WITH HYBRID AUTOMATIC RETRANSMISSION REQUEST (HARQ) FEEDBACK TRANSMISSION IN UNLICENSED SPECTRUM

(71) Applicant: QUALCOMM Incorporated, San Diego, CA (US)

(72) Inventors: Arthur GUBESKYS, San Diego, CA (US); Shuanshuan WU, San Diego, CA (US); Stelios STEFANATOS, San Diego, CA (US)

(21) Appl. No.: 17/996,592

(22) PCT Filed: Jun. 23, 2021
(86) PCT No.: PCT/US2021/038769

§ 371 Date: Oct. 19, 2022

(30) Foreign Application Priority Data
Jun. 24, 2020 (GR) 20200100364

(51) Int. Cl. H04L 1/1829; H04L 1/1607

(52) U.S. Cl. CPC H04L 1/1861; H04L 1/1671

(57) ABSTRACT

Certain aspects of the present disclosure provide techniques for slot format for sidelink communication. A method that may be performed by a user equipment (UE) includes transmitting a data signal; refraining from transmitting during a gap portion occurring in time after the transmission of the data signal, wherein the gap portion has a duration less than or equal to a threshold; receiving a feedback signal after the gap portion, wherein the feedback signal comprises at least a signal and hybrid automatic retransmission request (HARQ) feedback for the data signal; receiving another signal; and adjusting a gain applied to the other signal based on the signal.

### CROSS-REFERENCE TO RELATED APPLICATION

This application claims benefit of and priority to Greece Application No. 20200100364, filed Jun. 24, 2020, which is herein incorporated by reference in its entirety for all applicable purposes.

### INTRODUCTION

Aspects of the present disclosure relate to wireless communications, and more particularly, to techniques for sidelink communication in unlicensed spectrum.

Wireless communication systems are widely deployed to provide various telecommunication services such as telephony, video, data, messaging, broadcasts, etc. These wireless communication systems may employ multiple-access technologies capable of supporting communication with multiple users by sharing available system resources (e.g., bandwidth, transmit power, etc.). Examples of such multiple-access systems include 3rd Generation Partnership Project (3GPP) Long Term Evolution (LTE) systems, LTE Advanced (LTE-A) systems, code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems, to name a few.

These multiple access technologies have been adopted in various telecommunication standards to provide a common protocol that enables different wireless devices to communicate on a municipal, national, regional, and even global level. New radio (e.g., 5G NR) is an example of an emerging telecommunication standard. NR is a set of enhancements to the LTE mobile standard promulgated by 3GPP. NR is designed to better support mobile broadband Internet access by improving spectral efficiency, lowering costs, improving services, making use of new spectrum, and better integrating with other open standards using OFDMA with a cyclic prefix (CP) on the downlink (DL) and on the uplink (UL). To these ends, NR supports beamforming, multiple-input multiple-output (MIMO) antenna technology, and carrier aggregation.

However, as the demand for mobile broadband access continues to increase, there exists a need for further improvements in NR and LTE technology. Preferably, these improvements should be applicable to other multi-access technologies and the telecommunication standards that employ these technologies.

### SUMMARY

The systems, methods, and devices of the disclosure each have several aspects, no single one of which is solely responsible for its desirable attributes. Without limiting the scope of this disclosure as expressed by the claims which follow, some features will now be discussed briefly. After considering this discussion, and particularly after reading the section entitled “Detailed Description” one will understand how the features of this disclosure provide sidelink communications in unlicensed spectrums.

Certain aspects of the subject matter described in this disclosure can be implemented in a method for wireless communication. The method generally includes transmitting a data signal; refraining from transmitting during a gap portion occurring in time after the transmission of the data signal, wherein the gap portion has a duration less than or equal to a threshold; receiving a feedback signal after the gap portion, wherein the feedback signal comprises at least a signal and hybrid automatic retransmission request (HARQ) feedback for the data signal; receiving another signal; and adjusting a gain applied to the other signal based on the signal.

Certain aspects of the subject matter described in this disclosure can be implemented in a method for wireless communication. The method generally includes receiving, in sidelink control information (SCI), an indication that hybrid automatic retransmission request (HARQ) feedback is enabled for a data signal; receiving the data signal; refraining from transmitting during a gap portion occurring in time after the receiving of the data signal, wherein the gap portion has a duration less than or equal to a threshold; and transmitting a feedback signal that comprises a signal and HARQ feedback for the data signal.

Certain aspects of the subject matter described in this disclosure can be implemented in an apparatus for wireless communication. The apparatus generally includes a memory and a processor coupled to the memory. The processor and the memory are configured to: transmit a data signal, and refrain from transmitting during a gap portion occurring in time after the transmission of the data signal, wherein the gap portion has a duration in time less than or equal to a threshold, receive a feedback signal after the gap portion, wherein the feedback signal comprises at least a signal and hybrid automatic retransmission request (HARQ) feedback for the data signal, receive another signal; adjust a gain applied to the other signal based on the signal.

Certain aspects of the subject matter described in this disclosure can be implemented in an apparatus for wireless communication. The apparatus generally includes a memory and a processor coupled to the memory. The processor and the memory are configured to: receive, in sidelink control information (SCI), an indication that hybrid automatic retransmission request (HARQ) feedback is enabled for a data signal, receive the data signal, refrain from transmitting during a gap portion occurring in time after the receiving of the data signal, wherein the gap portion has a duration in time less than or equal to a threshold, and transmit, after the gap portion, a feedback signal that comprises a signal and HARQ feedback for the data signal.

Certain aspects of the subject matter described in this disclosure can be implemented in an apparatus for wireless communication. The apparatus generally includes means for transmitting a data signal; refraining from transmitting during a gap portion occurring in time after the transmission of the data signal, wherein the gap portion has a duration less than or equal to a threshold; means for receiving a feedback signal after the gap portion, wherein the feedback signal comprises at least a signal and hybrid automatic retransmission request (HARQ) feedback for the data signal; means for receiving another signal; and means for adjusting a gain applied to the other signal based on the signal.

Certain aspects of the subject matter described in this disclosure can be implemented in an apparatus for wireless communication. The apparatus generally includes means for receiving, in sidelink control information (SCI), an indication that hybrid automatic retransmission request (HARQ) feedback is enabled for a data signal; means for receiving the data signal; means for refraining from transmitting during a gap portion occurring in time after the receiving of the data signal, wherein the gap portion has a duration less than or equal to a threshold; and means for transmitting a feedback signal that comprises a signal and HARQ feedback for the data signal.

Certain aspects of the subject matter described in this disclosure can be implemented in a computer-readable medium for wireless communication. The computer-readable medium includes instructions that, when executed by a processing system, cause the processing system to perform operations generally including transmitting a data signal; refraining from transmitting during a gap portion occurring in time after the transmission of the data signal, wherein the gap portion has a duration less than or equal to a threshold; receiving a feedback signal after the gap portion, wherein the feedback signal comprises at least a signal and hybrid automatic retransmission request (HARQ) feedback for the data signal; receiving another signal; and adjusting a gain applied to the other signal based on the signal.

Certain aspects of the subject matter described in this disclosure can be implemented in a computer-readable medium for wireless communication. The computer-readable medium includes instructions that, when executed by a processing system, cause the processing system to perform operations generally including receiving, in sidelink control information (SCI), an indication that hybrid automatic retransmission request (HARQ) feedback is enabled for a data signal; receiving the data signal; refraining from transmitting during a gap portion occurring in time after the receiving of the data signal, wherein the gap portion has a duration less than or equal to a threshold; and transmitting a feedback signal that comprises a signal and HARQ feedback for the data signal.

Certain aspects of the subject matter described in this disclosure can be implemented in a method for wireless communication. The method generally includes transmitting a data signal; refraining from transmitting during a gap portion occurring in time after the transmission of the data signal, wherein the gap portion has a duration less than or equal to a value; and receiving a feedback signal after the gap portion, wherein the feedback signal comprises at least an automatic gain control (AGC) signal and hybrid automatic retransmission request (HARQ) feedback for the data signal.

Certain aspects of the subject matter described in this disclosure can be implemented in a method for wireless communication. The method generally includes receiving a data signal; refraining from transmitting during a gap portion occurring in time after the receiving of the data signal, wherein the gap portion has a duration less than or equal to a value; and transmitting a feedback signal that contains an automatic gain control (AGC) signal and hybrid automatic retransmission request (HARQ) feedback for the data signal.

Certain aspects of the subject matter described in this disclosure can be implemented in an apparatus for wireless communication. The apparatus generally includes means for transmitting a data signal; means for refraining from transmitting during a gap portion occurring in time after the transmission of the data signal, wherein the gap portion has a duration less than or equal to a value; and means for receiving a feedback signal after the gap portion, wherein the feedback signal comprises at least an automatic gain control (AGC) signal and hybrid automatic retransmission request (HARQ) feedback for the data signal.

Certain aspects of the subject matter described in this disclosure can be implemented in an apparatus for wireless communication. The apparatus generally includes means for receiving a data signal; means for refraining from transmitting during a gap portion occurring in time after the receiving of the data signal, wherein the gap portion has a duration less than or equal to a value; and means for transmitting a feedback signal that contains an automatic gain control (AGC) signal and hybrid automatic retransmission request (HARQ) feedback for the data signal.

Certain aspects of the subject matter described in this disclosure can be implemented in an apparatus for wireless communication. The apparatus generally includes a memory; and a processor coupled to the memory, the memory and the processor configured to: transmit a data signal; refrain from transmitting during a gap portion occurring in time after the transmission of the data signal, wherein the gap portion has a duration less than or equal to a value; and receive a feedback signal after the gap portion, wherein the feedback signal comprises at least an automatic gain control (AGC) signal and hybrid automatic retransmission request (HARQ) feedback for the data signal.

Certain aspects of the subject matter described in this disclosure can be implemented in an apparatus for wireless communication. The apparatus generally includes a memory; and a processor coupled to the memory, the memory and the processor configured to receive a data signal; refrain from transmitting during a gap portion occurring in time after the receiving of the data signal, wherein the gap portion has a duration less than or equal to a value; and transmit a feedback signal that contains an automatic gain control (AGC) signal and hybrid automatic retransmission request (HARQ) feedback for the data signal.

Certain aspects of the subject matter described in this disclosure can be implemented in a computer-readable medium for wireless communication. The computer-readable medium includes instructions that, when executed by a processing system, cause the processing system to perform operations generally including transmitting a data signal; refraining from transmitting during a gap portion occurring in time after the transmission of the data signal, wherein the gap portion has a duration less than or equal to a value; and receiving a feedback signal after the gap portion, wherein the feedback signal comprises at least an automatic gain control (AGC) signal and hybrid automatic retransmission request (HARQ) feedback for the data signal.

Certain aspects of the subject matter described in this disclosure can be implemented in a computer-readable medium for wireless communication. The computer-readable medium includes instructions that, when executed by a processing system, cause the processing system to perform operations generally including receiving a data signal; refraining from transmitting during a gap portion occurring in time after the receiving of the data signal, wherein the gap portion has a duration less than or equal to a value; and transmitting a feedback signal that contains an automatic gain control (AGC) signal and hybrid automatic retransmission request (HARQ) feedback for the data signal.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example a base station (BS) and user equipment (UE), in accordance with certain aspects of the present disclosure.

FIG. 3 is an example frame format for certain wireless communication systems (e.g., new radio (NR)), in accordance with certain aspects of the present disclosure.

FIG. 4A and FIG. 4B show diagrammatic representations of example vehicle to everything (V2X) systems, in accordance with certain aspects of the present disclosure.

FIG. 5 is a schematic diagram illustrating an example model of multiple wireless devices operating in an unlicensed spectrum, in accordance with certain aspects of the present disclosure.

FIG. 6 is an example transmission timeline of sidelink communications, in accordance with certain aspects of the present disclosure.

FIG. 7 is an example transmission timeline of sidelink communications, in accordance with certain aspects of the present disclosure.

FIGS. 8A and 8B are example transmission timelines of sidelink communications, according to aspects of the present disclosure.

FIGS. 9A and 9B are example transmission timelines of sidelink communications with gaps at the end of a slot, according to aspects of the present disclosure.

FIG. 10 is a flow diagram illustrating example operations for wireless communication by a UE, in accordance with certain aspects of the present disclosure.

FIG. 11 is a flow diagram illustrating example operations for wireless communication by a UE, in accordance with certain aspects of the present disclosure.

FIG. 12 illustrates a communications device that may include various components configured to perform the operations in FIG. 10, in accordance with aspects of the present disclosure.

FIG. 13 illustrates a communications device that may include various components configured to perform the operations in FIG. 11, in accordance with aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer readable mediums for sidelink communication with hybrid automatic retransmission request (HARQ) feedback transmission in unlicensed spectrum. An unlicensed spectrum refers to any frequency band(s) that are not subject to licensed use under regulatory practice, such that the frequency band(s) are open to use by any devices, and not just devices that have a license to use the particular frequency band(s). Example sidelink communications include vehicle-to-everything (V2X) communications. Though certain aspects may be discussed with respect to V2X communications in a V2X communications system, it should be noted that the aspects may equally apply to other suitable types of sidelink communications systems.

In certain aspects, for wireless communications in unlicensed spectrum, wireless communication devices (e.g., UEs and/or Wi-Fi devices) may perform a channel access procedure referred to as a listen-before-talk (LBT) procedure, where the devices may transmit if the channel, corresponding to a frequency band, is sensed to be free (e.g., idle) prior to transmitting. The time period prior to transmitting where the LBT procedure is performed may be referred to as a sensing occasion. In an LBT procedure, a wireless communication device measures energy on the frequency band and refrains from transmitting on the frequency band should the frequency band be busy, and determines it may communicate on the frequency band should the frequency band be idle. As used herein, the term “idle” for a frequency band means that energy as measured on the frequency band by a device determining idleness is below a threshold level. As used herein, the term “busy” for a frequency band means that energy as measured on the frequency band by the device determining idleness is above the threshold level. Such energy may be due to noise or signals within the frequency band.

In certain aspects, if a time period since a device previously transmitted on an unlicensed frequency band (e.g., a gap in transmission) is greater than a specific threshold (e.g., 16 μs), the device may perform an LBT procedure on the unlicensed frequency band before transmitting a signal on the unlicensed frequency band.

In certain aspects, sidelink communications may be scheduled with a gap time period (e.g., gap symbol in a slot) where UEs do not transmit or receive during the gap time period. In certain aspects, the gap time period may be referred to as a gap symbol. The gap symbol may enable a UE to switch from receive mode to transmit mode, or vice versa. The gap symbol may also account for delayed signal communication, such as due to the UEs not being synchronized in time thereby leading to propagation delay.

Sidelink communication may have hybrid automatic retransmission request (HARQ) feedback enabled, for example, to provide a level of quality of service (QoS). In a HARQ feedback process, a UE transmitting data may retransmit a packet, if a previous transmission of the packet failed; for example, a UE may retransmit a packet if negative acknowledgment (NACK) feedback is received in response to the packet from an intended recipient, e.g., a receiving UE, of the packet indicating the intended recipient received but was unable to successfully decode the packet.

Sidelink HARQ feedback transmissions in an unlicensed frequency band may also be subject to availability of the unlicensed frequency band as discussed with respect to the LBT procedure. In some examples of HARQ feedback mechanisms, a physical sidelink feedback channel (PSFCH) resource may be configured in every N time periods (e.g., slots), e.g., where N may be an integer (e.g., 0, 1, 2, or 4). In an example, the HARQ feedback timeline may be n+k, which means for a physical sidelink shared channel (PSSCH) transmission in slot n, a receiving UE will transmit the HARQ feedback in slot n+k, where slot n+k is the first slot having a PSFCH resource allocated that satisfies k≥2. In some examples of HARQ feedback techniques, a PSFCH transmission may occupy two time periods (e.g., symbols) of a slot. In one or more examples, the PSFCH transmission on the two symbols may be identical, but UEs receiving the PSFCH may decode the second symbol in time and use the first symbol in time for automatic gain control (AGC) training, which may be used to adjust the gain applied to received signals from that particular UE.

In certain cases, sidelink devices may use an automatic gain control signal to account for the near-far effect of received sidelink signals. Received sidelink signals from different transmitting UEs at a receiving UE may vary in power, for example, due to the varying distances between the transmitting UEs and the receiving UE. The automatic gain control signal may be transmitted by the transmitting UE to enable the receiving UE to adjust the gains applied to the received signals.

In some cases, HARQ feedback transmission resources may not be guaranteed, for example, due to the unlicensed frequency band being occupied by other wireless communication devices (such as a Wi-Fi device). According to aspects of the present disclosure, techniques are provided for transmitting a sidelink data transmission and sidelink feedback for the sidelink data transmission without performing LBT or other channel sensing of the unlicensed frequency band. For example, after a certain gap period, the receiving UE receiving data for which it transmits HARQ feedback may begin transmitting a signal (e.g., an AGC signal) to occupy the unlicensed frequency band. While transmitting the AGC signal, the receiving UE can process the signal from the transmitting UE, generate the HARQ feedback, and transmit the HARQ feedback to the transmitting UE without having to perform LBT for the transmission of the HARQ feedback. In particular, the AGC signal continues to occupy the unlicensed frequency band, thereby ensuring that other devices refrain from occupying the unlicensed frequency band, so that an LBT is not needed to be performed to ensure the unlicensed frequency band remains unoccupied. Aspects of the present disclosure may provide HARQ feedback performance, which may facilitate lower latencies and/or higher data rates, for example, due to the ability to send HARQ feedback without performing additional LBT or other channel sensing, as discussed.

Such techniques may be used, for example, in sidelink communications between wireless communication devices. In other examples, the wireless communication devices may include cellular vehicle-to-everything (CV2X) devices. It should be noted that though certain aspects are described with respect to CV2X devices and communication in the unlicensed band, it can be appreciated that the aspects may similarly be applicable to other scenarios, such as any communications (e.g., sidelink communications) in an unlicensed band, communications (e.g., sidelink communications) in a licensed band, etc.

The electromagnetic spectrum, such as in a licensed band, is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

The following description provides examples of transmitting a sidelink data transmission and sidelink feedback for the sidelink data transmission in a same time period (e.g., slot) in a wireless communications system, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method which is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs.

The techniques described herein may be used for various wireless networks and radio technologies. While aspects may be described herein using terminology commonly associated with 3G, 4G, and/or new radio (e.g., 5G NR) wireless technologies, aspects of the present disclosure can be applied in other generation-based communication systems.

NR access may support various wireless communication services, such as enhanced mobile broadband (eMBB) targeting wide bandwidth (e.g., 80 MHz or beyond), millimeter wave (mmW) targeting high carrier frequency (e.g., e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability requirements. These services may also have different transmission time intervals (TTI) to meet respective quality of service (QoS) requirements. In addition, these services may co-exist in the same subframe. NR supports beamforming and beam direction may be dynamically configured. MIMO transmissions with precoding may also be supported. MIMO configurations in the DL may support up to 8 transmit antennas with multi-layer DL transmissions up to 8 streams and up to 2 streams per UE. Multi-layer transmissions with up to 2 streams per UE may be supported. Aggregation of multiple cells may be supported with up to 8 serving cells.

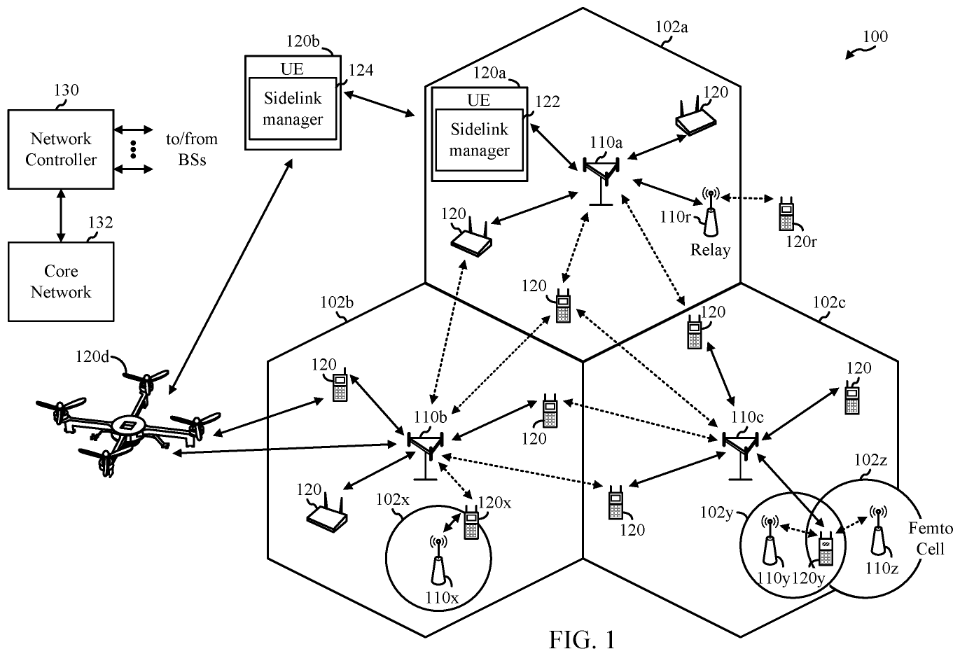

FIG. 1 illustrates an example wireless communication network 100 in which aspects of the present disclosure may be performed. For example, the wireless communication network 100 may be an NR system (e.g., a 5G NR network). As shown in FIG. 1, the wireless communication network 100 may be in communication with a core network 132. The core network 132 may in communication with one or more base station (BSs) 110 and/or user equipment (UE) 120 in the wireless communication network 100 via one or more interfaces.

According to certain aspects, the BSs 110 and UEs 120 may be configured for sidelink communication. As shown in FIG. 1, the UE 120a includes a sidelink manager 122. In certain aspects, the sidelink manager 122 refrains from transmitting during a gap portion of a first symbol of a slot, wherein the first symbol comprises the gap portion and an automatic gain control (AGC) portion, wherein the first symbol is after a data signal; receives a signal (e.g., an AGC signal used for AGC by a receiving UE) during the AGC portion of the first symbol; and receives hybrid automatic retransmission request (HARQ) feedback for the data signal during a second symbol of the slot, wherein the second symbol is after (e.g., and adjacent in time to) the AGC signal, in accordance with aspects of the present disclosure. For certain aspects, the sidelink manager 122 may transmit a data signal; refrain from transmitting during a gap portion occurring in time after the transmission of the data signal, wherein the gap portion has a duration less than or equal to a threshold; receive a feedback signal after the gap portion, wherein the feedback signal comprises at least a signal and HARQ feedback for the data signal; and adjust a gain applied to a received signal (e.g., the feedback signal and/or subsequently received signals) at a receiver based on the signal. In certain aspects, the sidelink manager 122 may receive, in sidelink control information (SCI), an indication that HARQ feedback is enabled for a data signal; receive the data signal; refrain from transmitting during a gap portion occurring in time after the receiving of the data signal, wherein the gap portion has a duration less than or equal to a value; and transmit a feedback signal that comprises a signal and HARQ feedback for the data signal.

A UE 120b includes a sidelink manager 124 that may be representative of the sidelink manager 122, in accordance with aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell”, which may be stationary or may move according to the location of a mobile BS 110. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b and 110c may be macro BSs for the macro cells 102a, 102b and 102c, respectively. The BS 110x may be a pico BS for a pico cell 102x. The BSs 110y and 110z may be femto BSs for the femto cells 102y and 102z, respectively. ABS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. In one example, a quadcopter, drone, or any other unmanned aerial vehicle (UAV) or remotely piloted aerial system (RPAS) 120d may be configured to function as a UE. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

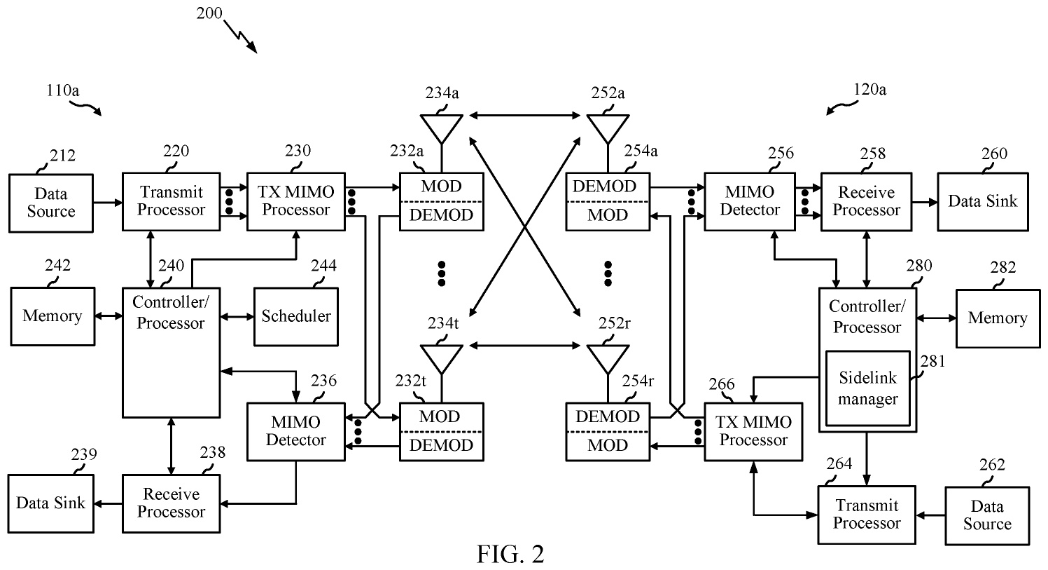

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) 232a-232t. Each modulator 232 may process a respective output symbol stream (e.g., for OFDM, etc.) to obtain an output sample stream. Each modulator may further process (e.g., convert to analog, amplify, filter, and upconvert) the output sample stream to obtain a downlink signal. Downlink signals from modulators 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator 254 may condition (e.g., filter, amplify, downconvert, and digitize) a respective received signal to obtain input samples. Each demodulator may further process the input samples (e.g., for OFDM, etc.) to obtain received symbols. A MIMO detector 256 may obtain received symbols from all the demodulators 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM, etc.), and transmitted to the BS 110a. At the BS 110a, the uplink signals from the UE 120a may be received by the antennas 234, processed by the modulators 232, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. For example, as shown in FIG. 2, the controller/processor 280 of the UE 120a has a sidelink manager 281 that may be representative of the sidelink manager 122, 124, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, etc.).

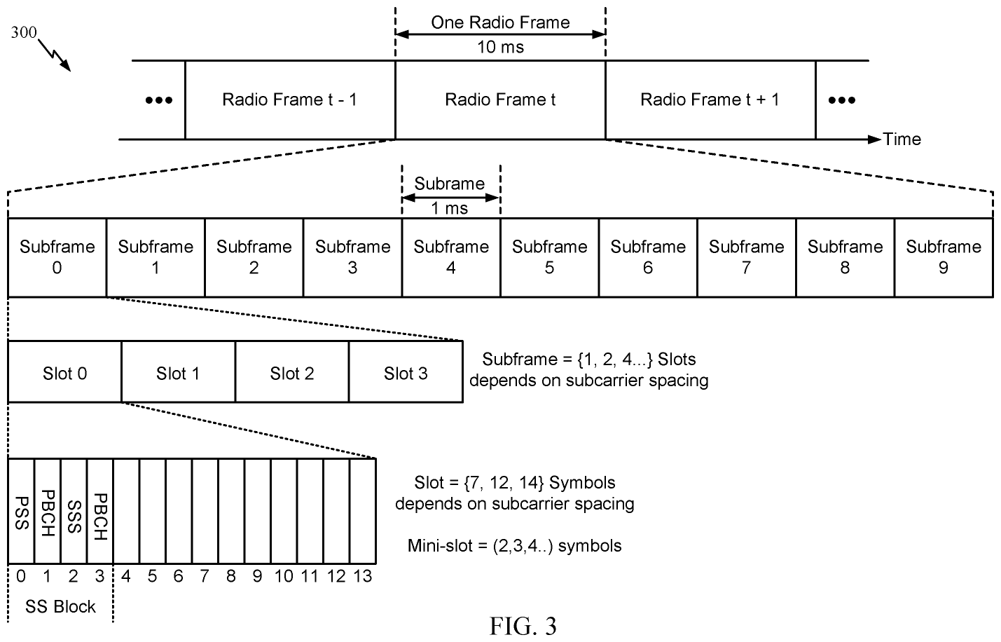

FIG. 3 is a diagram showing an example of a frame format 300 for NR. The transmission timeline for each of the downlink and uplink may be partitioned into units of radio frames. Each radio frame may have a predetermined duration (e.g., 10 ms) and may be partitioned into 10 subframes, each of 1 ms, with indices of 0 through 9. Each subframe may include a variable number of slots (e.g., 1, 2, 4, 8, 16, . . . slots) depending on the SCS. Each slot may include a variable number of symbol periods (e.g., 7, 12, or 14 symbols) depending on the SCS. The symbol periods in each slot may be assigned indices. A mini-slot, which may be referred to as a sub-slot structure, refers to a transmit time interval having a duration less than a slot (e.g., 2, 3, or 4 symbols). Each symbol in a slot may indicate a link direction (e.g., DL, UL, or flexible) for data transmission and the link direction for each subframe may be dynamically switched. The link directions may be based on the slot format. Each slot may include DL/UL data as well as DL/UL control information. In certain aspects, a feedback channel may occupy at least two symbols of a slot of the frame format 300.

In NR, a synchronization signal block (SSB) is transmitted. In certain aspects, SSBs may be transmitted in a burst where each SSB in the burst corresponds to a different beam direction for UE-side beam management (e.g., including beam selection and/or beam refinement). The SSB includes a PSS, a SSS, and a two symbol PBCH. The SSB can be transmitted in a fixed slot location, such as the symbols 0-3 as shown in FIG. 3. The PSS and SSS may be used by UEs for cell search and acquisition. The PSS may provide half-frame timing, the SS may provide the CP length and frame timing. The PSS and SSS may provide the cell identity. The PBCH carries some basic system information, such as downlink system bandwidth, timing information within radio frame, SS burst set periodicity, system frame number, etc. The SSBs may be organized into SS bursts to support beam sweeping. Further system information such as, remaining minimum system information (RMSI), system information blocks (SIBs), other system information (OSI) can be transmitted on a physical downlink shared channel (PDSCH) in certain subframes. The SSB can be transmitted up to sixty-four times, for example, with up to sixty-four different beam directions for mmWave. The multiple transmissions of the SSB are referred to as a SS burst set. SSBs in an SS burst set may be transmitted in the same frequency region, while SSBs in different SS bursts sets can be transmitted at different frequency regions.

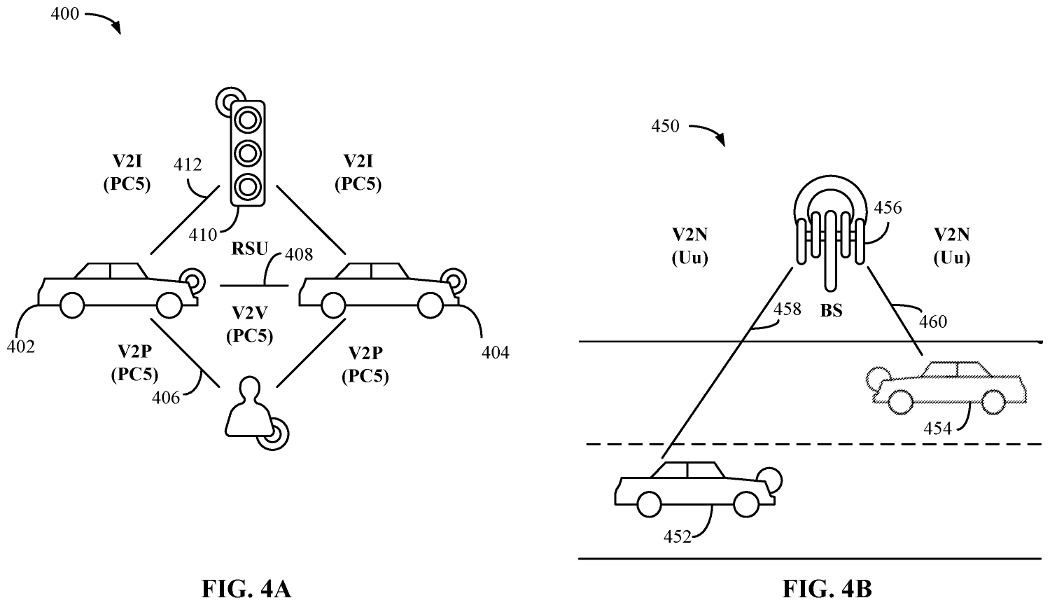

FIG. 4A and FIG. 4B show diagrammatic representations of example V2X systems, in accordance with some aspects of the present disclosure. For example, the vehicles shown in FIG. 4A and FIG. 4B may communicate via sidelink channels and may relay sidelink transmissions as described herein. The V2X systems, may be examples of sidelink communication systems discussed herein, and the vehicles and other devices may be configured to communicate over sidelink frequency channels as discussed herein.

The V2X systems provided in FIG. 4A and FIG. 4B provide two complementary transmission modes. A first transmission mode (also referred to as mode 4), shown by way of example in FIG. 4A, involves direct communications (for example, also referred to as sidelink communications) between participants in proximity to one another in a local area. A second transmission mode (also referred to as mode 3), shown by way of example in FIG. 4B, involves network communications through a network, which may be implemented over a Uu interface (for example, a wireless communication interface between a radio access network (RAN) and a UE).

Referring to FIG. 4A, a V2X system 400 (for example, including vehicle-to-vehicle (V2V) communications) is illustrated with two vehicles 402, 404. The first transmission mode allows for direct communication between different participants in a given geographic location. As illustrated, a vehicle can have a wireless communication link 406 with an individual (V2P) (for example, via a UE) through a PC5 interface. Communications between the vehicles 402 and 404 may also occur through a PC5 interface 408. In a like manner, communication may occur from a vehicle 402 to other highway components (for example, highway component 410), such as a traffic signal or sign (V2I) through a PC5 interface 412. With respect to each communication link illustrated in FIG. 4A, two-way communication may take place between elements, therefore each element may be a transmitter and a receiver of information. The V2X system 400 may be a self-managed system implemented without assistance from a network entity. A self-managed system may enable improved spectral efficiency, reduced cost, and increased reliability as network service interruptions do not occur during handover operations for moving vehicles. The V2X system may be configured to operate in a licensed or unlicensed spectrum, thus any vehicle with an equipped system may access a common frequency and share information. Such harmonized/common spectrum operations allow for safe and reliable operation.

FIG. 4B shows a V2X system 450 for communication between a vehicle 452 and a vehicle 454 through a network entity 456. These network communications may occur through discrete nodes, such as a BS (e.g., the BS 110a), that sends and receives information to and from (for example, relays information between) vehicles 452, 454. The network communications through vehicle to network (V2N) links 458 and 460 may be used, for example, for long-range communications between vehicles, such as for communicating the presence of a car accident a distance ahead along a road or highway. Other types of communications may be sent by the wireless node to vehicles, such as traffic flow conditions, road hazard warnings, environmental/weather reports, and service station availability, among other examples. Such data can be obtained from cloud-based sharing services.

Roadside units (RSUs) may be utilized. An RSU may be used for V2I communications. In some examples, an RSU may act as a forwarding node to extend coverage for a UE. In some examples, an RSU may be co-located with a BS or may be standalone. RSUs can have different classifications. For example, RSUs can be classified into UE-type RSUs and Micro NodeB-type RSUs. Micro NodeB-type RSUs have similar functionality as a Macro eNB or gNB. The Micro NodeB-type RSUs can utilize the Uu interface. UE-type RSUs can be used for meeting tight quality-of-service (QoS) requirements by minimizing collisions and improving reliability. UE-type RSUs may use centralized resource allocation mechanisms to allow for efficient resource utilization. Critical information (e.g., such as traffic conditions, weather conditions, congestion statistics, sensor data, etc.) can be broadcast to UEs in the coverage area. Relays can re-broadcasts critical information received from some UEs. UE-type RSUs may be a reliable synchronization source.

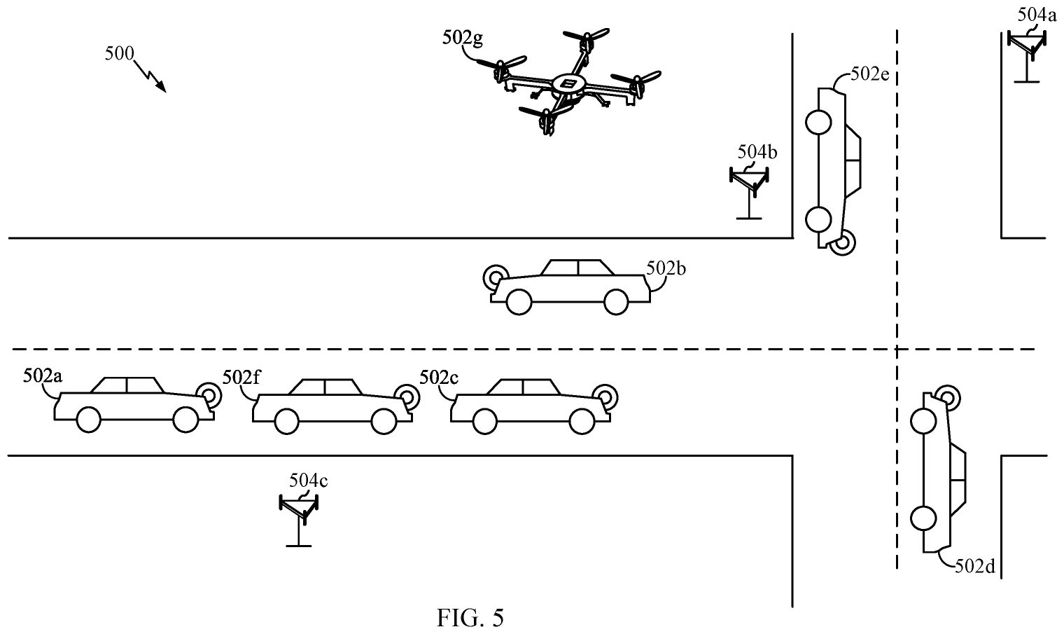

FIG. 5 is a schematic diagram illustrating an example network 500 of multiple CV2X devices operating in an unlicensed spectrum. The unlicensed spectrum may be an example of a sidelink frequency band. Further, the network 500 may be an example of a sidelink communication system. The CV2X devices 502 may be configured to communicate on sidelink frequency channels as discussed herein. For example, any of the CV2X devices 502 may communicate with any other of the CV2X devices 502.

In the illustrated example, seven CV2X devices (e.g., a first CV2X device 502a, a second CV2X device 502b, a third CV2X device 502c, a fourth CV2X device 502d, a fifth CV2X device 502e, a sixth CV2X device 502f, and a seventh CV2X device 502g)—collectively referred to as CV2X devices 502) may operate in an unlicensed spectrum with other non-CV2X devices (e.g., non-CV2X devices 504a-c—collectively referred to as non-CV2X devices 504). In some examples, the first CV2X device 502a, the sixth CV2X device 502f, and the third CV2X device 502c may be part of a fleet or platoon. In transportation, platooning or flocking is a method for driving a group of vehicles together. It is meant to increase the capacity of roads via an automated highway system. Platoons decrease the distances between cars or trucks, such as based on SL communications.

Although the example provided is illustrative of six automotive CV2X devices in a traffic setting and a drone or other aerial vehicle CV2X device, it can be appreciated that CV2X devices and environments may extend beyond these, and include other wireless communication devices and environments. For example, the CV2X devices 502 may include UEs (e.g., UE 120 of FIG. 1) and/or road-side units (RSUs) operated by a highway authority, and may be devices implemented on motorcycles or carried by users (e.g., pedestrian, bicyclist, etc.), or may be implemented on another aerial vehicle such as a helicopter.

The CV2X devices 502 may include UEs (e.g., UE 120 of FIG. 1), and may be devices implemented on motorcycles or carried by users (e.g., pedestrian, bicyclist, etc.), or implemented as a roadside unit.

In certain aspects, sidelink communications (e.g., vehicle-to-everything (V2X) communications) may happen in a time-division duplexing (TDD) manner. That is, a UE communicating in sidelink both transmits and receives sidelink signals in the same carrier or frequency band, but transmits at different times than it receives. When a user equipment (UE) communicates in a TDD manner, in certain aspects, the UE may be scheduled to neither transmit nor receive during a period (e.g. a gap period, which may be a gap symbol), such that the UE's hardware (e.g., radio front-end) can switch from transmit (Tx) mode to receive (Rx) mode, or vice-versa. In certain aspects, sidelink communications may be decoupled from synchronization, meaning they are not synchronized in time, as there may be no central unit providing synchronization. For example, a receiving UE may receive sidelink transmissions from a device A (e.g., another UE), but may be synchronized to a device B (e.g., another UE, a base station (BS), or a global navigation satellite system (GNSS)). The decoupling may lead to a propagation delay of unknown length at the receiving UE, for example, for the sidelink transmissions from the device A due to the difference in synchronization sources. The gap period may accommodate such propagation delay, as since nothing is scheduled for transmission or reception during the gap period, the receiving UE is able to receive the delayed signal during the gap period without it conflicting with other communications.

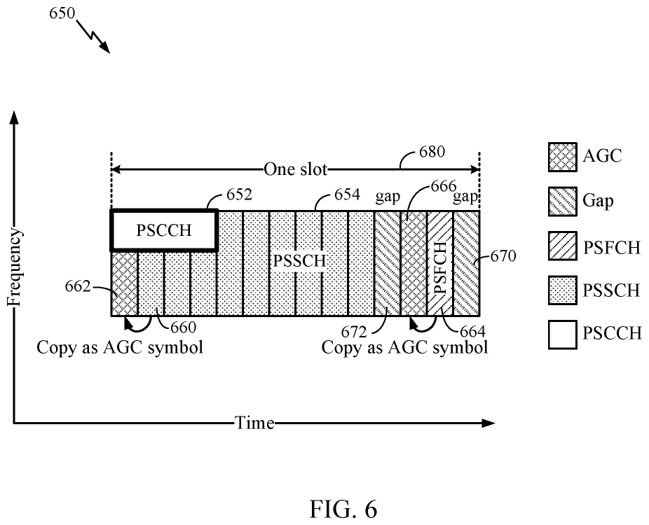

In certain aspects, such as in certain CV2X systems, the last symbol in time of a slot may be reserved as a gap period referred to as a gap symbol for certain UEs, meaning there may be no signal scheduled for transmission in this gap symbol and the UEs may not be scheduled to receive in the gap symbol. The gap symbol may provide enough time for a UE to switch from Tx (or Rx) mode to Rx (or Tx) mode, for example. In certain aspects, when a slot has physical sidelink feedback channel (PSFCH) (for hybrid automatic retransmission request (HARM) feedback) resources configured, there may be two OFDM symbols reserved as gaps (see description below with reference to FIG. 6).

In certain aspects, sidelink communications may have a near-far effect. For example, a receiving UE receives a transmission at a higher power if the transmitting UE is closer to the receiving UE (e.g., 100 meters) than if the transmitting UE is far away from the receiving UE (e.g., 1 km). Therefore, received signal powers may vary across slots at a receiving UE. In certain aspects, a first symbol in time in a slot (or a transmission) may be used for automatic gain control (AGC) training to adjust a gain used by the UE for transmitting to accommodate for the near-far effect. In certain cases, a receiving UE may not decode the AGC symbol, and thus the AGC symbol need not carry useful information. For example, in certain aspects, the AGC symbol may be a copy of the next symbol transmitted within the slot.

FIG. 6 is an example transmission timeline 650 of sidelink communications. In the transmission timeline 650, PSFCH resources are configured in the symbol 664. A UE (e.g., UE 120a, shown in FIG. 1) transmits a physical sidelink control channel (PSCCH) 652 that allocates other symbols in the slot 680 for a physical sidelink shared channel (PSSCH) 654. As previously mentioned, the UE copies the OFDM symbol 660 into the symbol at 662 for use as an AGC symbol. Another UE, (e.g., UE 120b, shown in FIG. 1) receives the PSCCH 652 and the PSSCH 654. The other UE transmits HARQ feedback regarding the PSSCH 654 on a PSFCH during the symbol 664. The other UE copies the OFDM symbol 664 into the symbol 666 for use as an AGC symbol. Both UEs refrain from transmitting during the final symbol 670 of the slot and during the symbol 672 prior to (e.g., and adjacent in time to) the AGC symbol 666.

A UE may transmit a data packet (e.g., in a PSSCH) and expect HARQ feedback (e.g., in a PSFCH) from one (if the data packet was sent in a unicast transmission) or multiple (if the data packet was sent in a groupcast transmission) receiving UEs.

A receiving UE may need a minimum amount of time to decode the data transmission; in other words, the receiving UE may not be able to transmit HARQ feedback immediately following the data channel reception. For example, if a receiving UE receives a data transmission in slot n, the receiving UE may be ready to transmit HARQ feedback in a later slot n+k. However, transmitting the HARQ feedback may also be subject to LBT in unlicensed spectrum. Thus, there may be a gap between the end of a PSSCH transmission and the start of a PSFCH transmission responding to the PSSCH transmissions, due to processing at the receiving UE. If the gap is larger than a threshold, then UEs (e.g., the UE that transmitted the PSSCH and the UE that received the PSSCH) cannot assume that the channel is still available for HARQ feedback transmission, and thus, LBT will be performed, in certain cases; it is possible that the channel is no longer available (e.g., occupied by other technologies or devices) for the HARQ feedback transmission.

In certain cases, the threshold of the gap may be 16 microseconds (μs), meaning that a transmitting device (e.g., a UE) will perform an LBT, if the gap is more than 16 μs. In certain cases, the threshold of the gap may be different depending on the region.

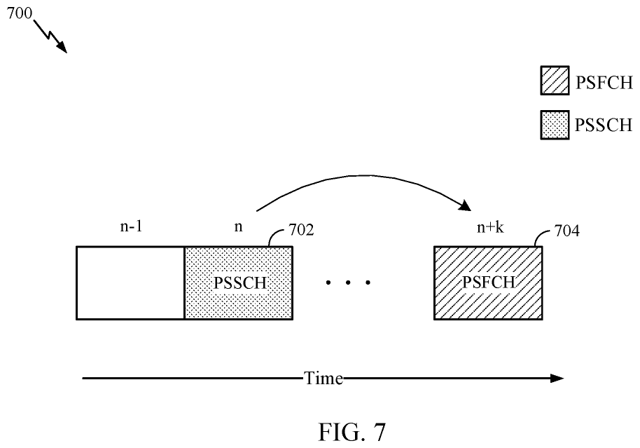

FIG. 7 is an example transmission timeline 700 illustrating the above described sidelink feedback technique. Timeline 700 illustrates slots n−1 to n+k, each of which may have a slot structure according to the one slot shown in FIG. 6. In the example transmission timeline, a first UE (e.g., UE 120a in wireless communications network 100) transmits a PSSCH in slot 702 to a second UE (e.g., UE 120b in wireless communications network 100). In slot 704, the second UE may be scheduled to transmit feedback to the first UE, as discussed. As the transmission of HARQ feedback may be subject to LBT procedures, the channel may not be idle for the feedback transmission, which may delay retransmissions from the first UE to the second UE.

Accordingly, certain aspects provide techniques and apparatus for transmitting a sidelink data transmission and sidelink feedback for the sidelink data transmission without requiring a receiving UE to perform an LBT before transmitting the feedback in a wireless communications system.

### Example Sidelink Communication with HARQ Feedback Transmission in Unlicensed Spectrum

Aspects of the present disclosure provide techniques for sidelink communication with hybrid automatic retransmission request (HARQ) feedback transmission in an unlicensed frequency band. In certain aspects of the present disclosure, a first UE may transmit a sidelink data transmission and receive a signal containing the corresponding sidelink feedback from a second UE receiving the sidelink data transmission, following a gap that is no greater than a threshold. Similarly, a second UE may receive the sidelink data transmission, refrain from transmitting during a gap that is no greater than a threshold, and transmit a signal containing the corresponding sidelink feedback information following the gap.

According to aspects of the present disclosure, a data-transmitting UE transmits data in unlicensed spectrum for sidelink communication, and one or multiple data-receiving UEs may receive the data transmission from the transmitting UE. Aspects of the present disclosure may provide HARQ feedback techniques, which may facilitate lower latencies and/or higher data rates, for example, due to the ability to send HARQ feedback without performing LBT or other channel sensing by the receiving UEs.

In certain aspects of the present disclosure, if HARQ feedback is enabled (e.g., requested by a data-transmitting UE via sidelink control information), then a feedback signal containing a signal and HARQ feedback may be transmitted (e.g., by the one or multiple data-receiving UEs) following the data reception; transmitting the feedback signal containing HARQ feedback may follow a gap that is no greater than (e.g., less than or equal to) a threshold. In some aspects, the signal may be used by a receiving UE to perform AGC, and be referred to as an AGC signal. Therefore, the unlicensed frequency band is continuously occupied by one of the data-transmitting UE (transmitting data) and the data-receiving UE (transmitting HARQ feedback), and a UE (e.g., a data-receiving UE) can transmit HARQ feedback without performing LBT or other channel sensing on the unlicensed frequency band.

According to aspects of the present disclosure, there may be a gap between a data-transmitting UE data transmission (e.g., a PSSCH) and a data-receiving UE transmission (e.g., a PSFCH containing an AGC signal and HARQ feedback), as long as the gap is no greater than a threshold (e.g., 16 μs or a gap for turnaround), which may be a threshold (e.g., as specified in a wireless communications standard and/or regulations for wireless communications in an unlicensed spectrum).

In certain aspects of the present disclosure, a data-receiving UE may transmit an AGC signal in a symbol (e.g., referred to as an AGC symbol) preceding (e.g., and adjacent to) a HARQ feedback transmission.

According to aspects of the present disclosure, an AGC signal (e.g., an AGC signal transmitted preceding (e.g., and adjacent to) a HARQ feedback) may carry pre-determined information (e.g., a configured sequence), so the content of the AGC signal does not rely on a PSSCH decoding outcome, and the data-receiving UE is able to transmit the AGC signal (e.g., immediately) following reception of the PSSCH. That is, because a data-receiving UE transmits pre-determined information in an AGC signal instead of duplicating the signal transmitted in the following symbol (see FIG. 6), the data-receiving UE can transmit the AGC before the UE has completed decoding the PSSCH and preparing the HARQ feedback (e.g., in a PSFCH).

In certain aspects of the present disclosure, while the data-receiving UE is transmitting an AGC signal, the data-receiving UE may perform PSSCH decoding and PSFCH processing.

According to aspects of the present disclosure, the data-receiving UE may transmit HARQ feedback (e.g., a PSFCH) that follows the AGC signal transmission.

In aspects of the present disclosure, duration of the gap is smaller than a threshold (e.g., 16 μs or 25 μs or another threshold, as may be specified by regional regulators), so data-receiving UEs may access the unlicensed frequency band and transmit a feedback signal(s). For example, a data-receiving UE can transmit an AGC signal and HARQ feedback following the gap (which is smaller than a threshold) without performing LBT.

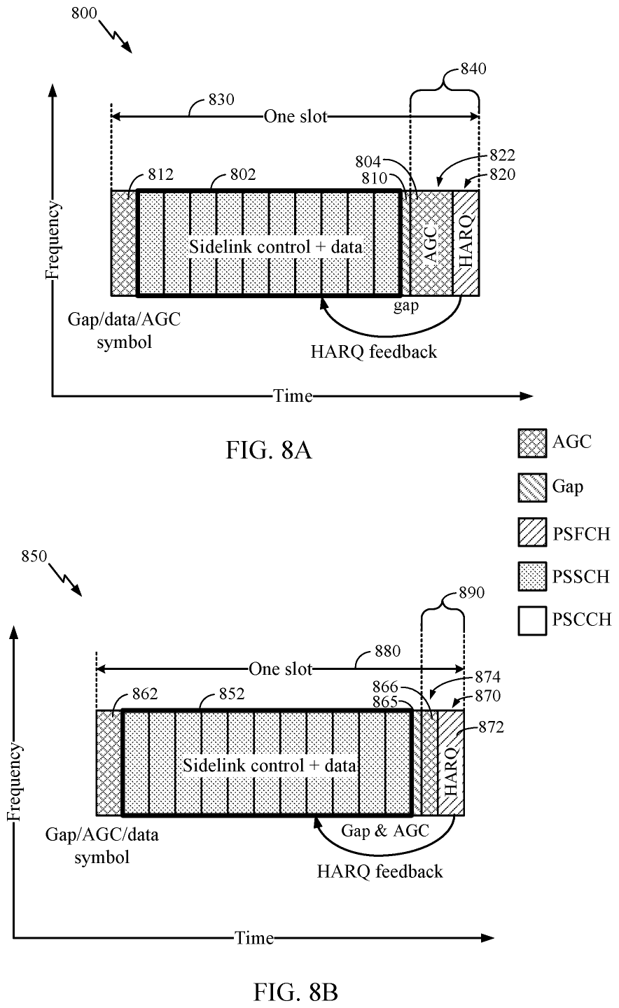

FIGS. 8A and 8B are example transmission timelines 800 and 850 of sidelink communications, according to aspects of the present disclosure. In the transmission timeline 800, HARQ feedback from a UE (e.g., UE 120a) responsive to a sidelink data transmission 802 during a slot 830 is mapped to a HARQ feedback 820, which may have a duration of one symbol, in the slot 830. The UE also transmits an AGC signal 822, which may occupy less than two symbols 804 in the slot. There is a gap 810 between the sidelink data transmission and the combination of the AGC and PSFCH transmission. That is, the UE may transmit a feedback signal 840 comprising the HARQ feedback 820 and the AGC signal 822 after the gap 810. In certain aspects, the gap is not greater than a threshold (e.g., 16 μs or 25 μs) so the UE can transmit the AGC and HARQ feedback without performing an LBT, as discussed. Therefore, in certain aspects, AGC signal transmission may occupy a fraction of a symbol duration so the gap that is no greater than the threshold can be accommodated preceding the fractional part of the AGC signal (e.g., the AGC symbol may have an extra-large CP length; the symbol after the data transmission may contain the gap and part of the extra-large CP length). A total of 3 symbols are used for the combination of the gap, the AGC, and the HARQ feedback, and thus a data-receiving UE has 2 symbols' time (e.g., containing the gap and the AGC) for PSSCH decoding and HARQ feedback processing. At the beginning of the slot 830, one symbol 812 may be used as another gap, as an AGC symbol, or for data transmission.

In the transmission timeline 850, HARQ feedback 870 transmitted by a UE (e.g., UE 120b in wireless communications network 100) is mapped to a symbol 872 in a slot 880. In this example, the UE also transmits an AGC signal 874 in a symbol 866. There is a gap 865 between a sidelink data transmission 852 and the feedback signal 890 comprising the AGC signal 874 and HARQ feedback signal 870. In certain aspects, the AGC signal may occupy only part of a symbol, so the gap can be in the beginning of the symbol accommodating the AGC signal. In this example, a total of 2 symbols are used for the combination of the gap, the AGC signal, and the HARQ feedback, and thus a data-receiving UE has 1 symbol's time (e.g., containing the gap and the AGC) for PSSCH decoding and PSFCH processing. At the beginning of the slot, one symbol 862 may be used as another gap, as an AGC symbol, or for data transmission.

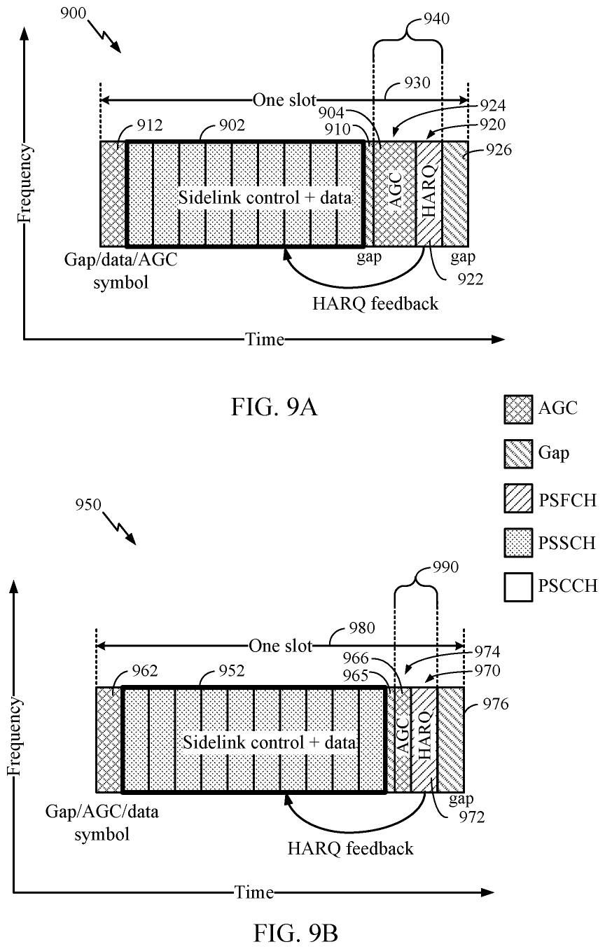

FIGS. 9A and 9B are example transmission timelines 900 and 950 of sidelink communications with gaps at the end of a slot, according to aspects of the present disclosure. In the transmission timeline 900, HARQ feedback 920 from a UE (e.g., UE 120a) responsive to a sidelink data transmission 902 during a slot 930 is mapped to symbol 922 in the slot. The UE also transmits an AGC signal 924 that may occupy more than two symbols 904 in the slot 930. There is a gap 910 between the sidelink data transmission 902 and the feedback signal 940, which includes the AGC signal 924 and the HARQ feedback 920. In certain aspects, the gap is not to be greater than a threshold (e.g., 16 μs or 25 μs) so the UE can transmit the AGC and PSFCH without performing an LBT. Therefore, in certain aspects, part of the AGC symbol may be copied and transmitted earlier than the symbol 904 so the gap time is no greater than the threshold (e.g., the AGC symbol may have an extra-large cyclic prefix (CP) length). In certain aspects, a total of 3 symbols are used for the combination of the gap, the AGC, and the HARQ feedback, and thus a data-receiving UE has 2 symbols' time (e.g., containing the gap and the AGC) for PSSCH decoding and PSFCH processing. At the beginning of the slot, one symbol 912 may be used as another gap, as an AGC symbol, or for data transmission. Another gap may be included in the last symbol 926 of the slot.

In the transmission timeline 950, HARQ feedback 970 transmitted by a UE (e.g., UE 120b in wireless communications network 100) is mapped to a symbol 972 in a slot 980. The UE also transmits an AGC signal 974 in a symbol 966. There is a gap 965 between a sidelink data transmission 952 and the feedback signal 990 comprising the AGC signal 974 and HARQ feedback 970. The AGC signal may occupy only part of a symbol, so the gap can be in the beginning of the symbol accommodating the AGC symbol. A total of 2 symbols are used for the combination of the gap, the AGC, and the HARQ feedback, and thus a data-receiving UE has 1 symbol's time (e.g., containing the gap and the AGC) for PSSCH decoding and PSFCH processing. At the beginning of the slot, one symbol 962 may be used as another gap, as an AGC symbol, or for data transmission. Another gap may be included in the last symbol 976 of the slot.

While the examples shown in FIGS. 8A-B and 9A-B show a combination of a gap and an AGC signal occupying 1 symbol (e.g., 865 and 866 in FIG. 8B or 965 and 966 in FIG. 9B) or 2 symbols (e.g., 804 and 810 in FIG. 8A or 904 and 910 in FIG. 9A), the present disclosure is not so limited, and a combination of a gap and AGC signal may occupy other numbers of symbols, N, greater than 2. In such cases, a portion of the N symbols may include a gap, and the remaining portion may include an AGC signal.

According to aspects of the present disclosure, HARQ feedback transmissions may be enabled by a data-transmitting UE. For example, a data-transmitting UE may indicate in sidelink control information (SCI) that HARQ feedback is requested.

In certain aspects of the present disclosure, if HARQ feedback is requested, then a data-receiving UE stops receiving from a data-transmitting UE at a configured symbol. For example, another UE or the data transmitting UE provides to the data receiving UE, via SCI, the duration of the data signal, or a common configuration, which indicates the last symbol available for a data transmission in a slot. For example, the data-receiving UE may be (pre)configured or scheduled such that the last symbol for data transmission is the 11^{th} symbol in the slot (e.g., for symbols in a slot with normal cyclic prefix (CP) length), if HARQ feedback is requested, so the data-receiving UE switches to transmit mode after the 11^{th} symbol and then transmits an AGC signal and HARQ feedback, as described previously.

According to aspects of the present disclosure, if HARQ feedback is not requested, then a data-receiving UE may stop receiving from a data-transmitting UE at a different configured symbol, such as similarly configured via SCI. For example, a data-receiving UE may be (pre)configured such that the last symbol for data transmission is the 14^{th} symbol in the slot (e.g., for a slot with symbols with normal CP length), if HARQ feedback is not requested.

In certain aspects of the present disclosure, a data-receiving UE knows which symbol is the last symbol in a data transmission after decoding sidelink control signaling (e.g., SCI) scheduling the data transmission and behaves accordingly.

According to certain aspects of the present disclosure, transmission of an AGC signal is independent of information in a PSFCH or other data channel, so transmission of the AGC symbol does not depend on a data channel decoding outcome. For example, an AGC symbol may carry a pre-determined sequence (e.g., a (pre)configured low-peak-to-average-power-ratio (low-PAPR) sequence)), as discussed.

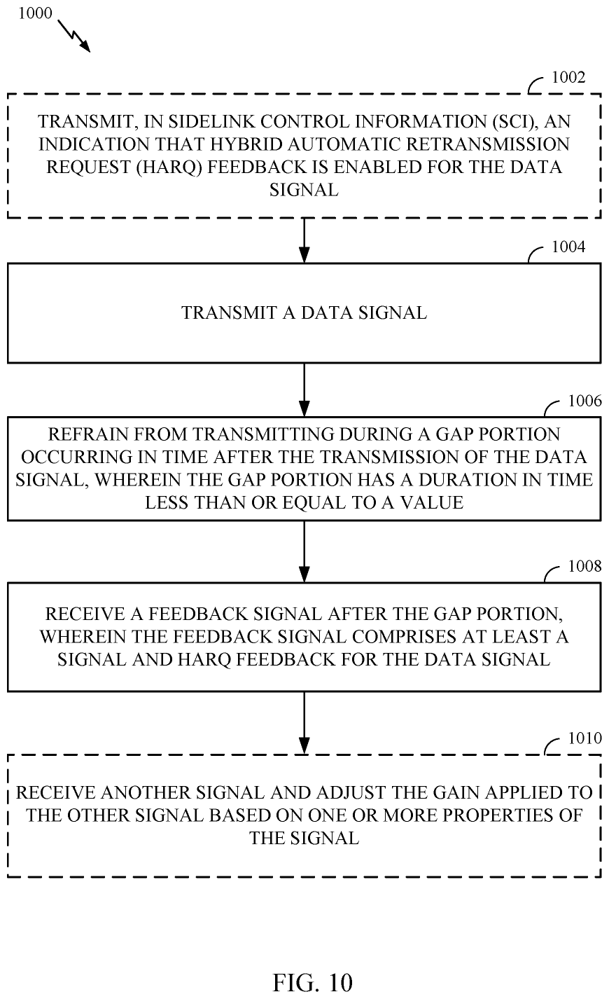

FIG. 10 is a flow diagram illustrating example operations 1000 for wireless communication, in accordance with certain aspects of the present disclosure. The operations 1000 may be performed, for example, by a UE (e.g., the UE 120a in the wireless communication network 100). The operations 1000 may be implemented as software components that are executed and run on one or more processors (e.g., controller/processor 280 of FIG. 2). Further, the transmission and reception of signals by the UE in operations 1000 may be enabled, for example, by one or more antennas (e.g., antennas 252 of FIG. 2). In certain aspects, the transmission and/or reception of signals by the UE may be implemented via a bus interface of one or more processors (e.g., controller/processor 280) obtaining and/or outputting signals.

The operations 1000 may optionally begin, at block 1002 where the UE may transmit, in sidelink control information (SCI) in the slot, an indication that HARQ feedback is enabled for the data signal

At block 1004, the UE may transmit a data signal. The data signal may include various content, such as application data, sensor data, and/or V2X data.

At block 1006, operations 1000 may continue where the UE may refrain from transmitting during a gap portion occurring in time after the transmission of the data signal, wherein the gap portion has a duration less than or equal to a value (e.g., a threshold).

Operations 1000 may continue at block 1008 where the UE may receive a feedback signal after the gap portion, wherein the feedback signal comprises at least a signal and hybrid automatic retransmission request (HARQ) feedback for the data signal.

In aspects, the signal may include an AGC signal. Optionally at block 1010, the UE may receive another signal and adjust the gain applied to the other signal (e.g., subsequent signal(s)) at a receiver based on one or more properties of the signal (e.g., the received power of the signal). For example, the UE may identify that the received power of the AGC signal is high, and the UE may decrease the gain applied to signals received from the other UE, which transmitted the AGC signal.

In some such aspects, the SCI further indicates a symbol, wherein the data signal ends during the symbol, and the device may also determine another symbol, based on the symbol, for the reception of the feedback signal. That is, the SCI may indicate a symbol where the data signal ends, and the UE may receive the feedback signal in at least another symbol after the symbol. Expressed another way, the SCI may indicate the duration of the data signal, and the UE may initiate refraining from transmitting based on the duration of the data signal.

In aspects of the present disclosure, the threshold of block 1006 may be one of fixed or configured from a set of candidate values.

According to aspects of the present disclosure, the feedback signal of block 1006 may be received over at least 3 symbols including a first symbol in time, a second symbol in time, and a third symbol in time, wherein the gap portion occurs during the first symbol, the AGC signal is received during the first symbol and the second symbol, and the HARQ feedback is received during the third symbol. In other words, at block 1008, the UE may receive the feedback signal over at least 3 symbols comprising a first symbol in time, a second symbol in time, and a third symbol in time, where the gap portion occurs during the first symbol. The UE may receive the signal during the first symbol and the second symbol, and receive the HARQ feedback during the third symbol.

In aspects of the present disclosure, the feedback signal of block 1008 may be received over at least 2 symbols including a first symbol in time and a second symbol in time, wherein the gap portion occurs during the first symbol, the AGC signal is received during the first symbol, and the HARQ feedback is received during the second symbol. That is, at block 1008, the UE may receive the feedback signal over at least 2 symbols comprising a first symbol in time and a second symbol in time, where the gap portion occurs during the first symbol. The UE may receive the signal during the first symbol, and receive the HARQ feedback during the second symbol.

According to aspects of the present disclosure, the feedback signal of block 1006 may be received over a plurality of symbols comprising a first one or more symbols in time and a second one or more symbols in time, wherein the gap portion occurs during one of the first one or more symbols, the AGC signal is received during the first one or more symbols, and the HARQ feedback is received during the second one or more symbols. In other words, at block 1008, the UE may receive the feedback signal over a plurality of symbols comprising a first one or more symbols in time and a second one or more symbols in time, where the gap portion occurs during one of the first one or more symbols. The UE may receive the signal during the first one or more symbols, and receive the HARQ feedback during the second one or more symbols.

In certain aspects, the UE may receive the feedback within the same slot in which the data signal is transmitted. For example, the UE may transmit at least a portion of the data signal in a slot and refrain from transmitting during the gap portion in the slot. The UE may receive the feedback signal in the slot.

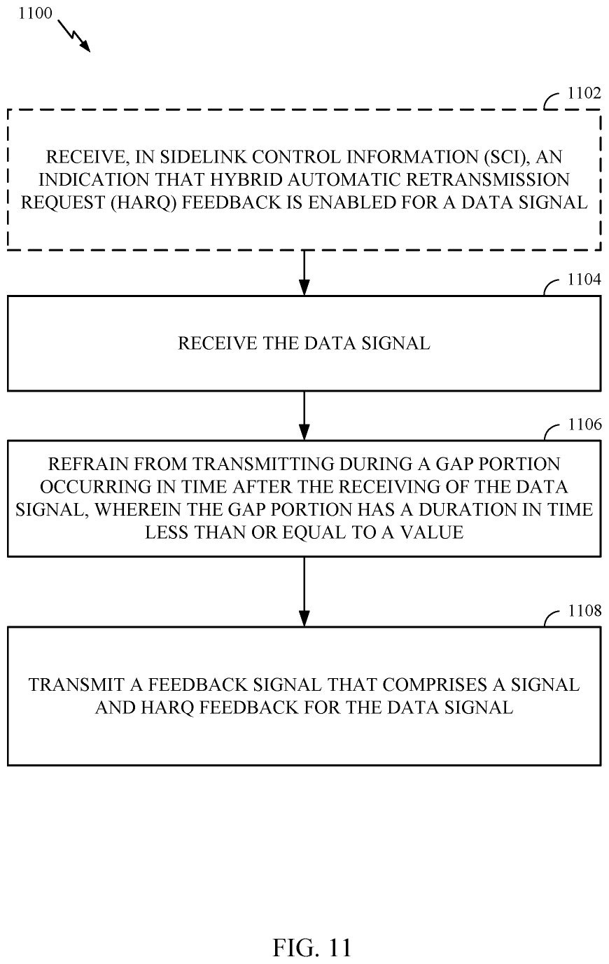

FIG. 11 is a flow diagram illustrating example operations 1100 for wireless communication, in accordance with certain aspects of the present disclosure. The operations 1100 may be performed, for example, by another UE (e.g., the UE 120b in the wireless communication network 100). The operations 1100 may be complimentary to the operations 1000 performed by the UE. The operations 1100 may be implemented as software components that are executed and run on one or more processors (e.g., controller/processor 280 of FIG. 2). Further, the transmission and reception of signals by the UE in operations 1100 may be enabled, for example, by one or more antennas (e.g., antennas 252 of FIG. 2). In certain aspects, the transmission and/or reception of signals by the BS may be implemented via a bus interface of one or more processors (e.g., controller/processor 280) obtaining and/or outputting signals.

The operations 1100 may begin, at block 1102, where the UE may receive, in SCI, an indication that HARQ feedback is enabled for a data signal.

At block 1104, the UE may receive a data signal.

At block 1106, operations 1100 may continue where the UE may refrain from transmitting during a gap portion occurring in time after the receiving of the data signal, where the gap portion has a duration less than or equal to a value (e.g., a threshold).

Operations 1100 may continue at block 1108 where the UE may transmit a feedback signal that comprises signal and HARQ feedback for the data signal. In aspects, the signal may include an AGC signal. For example, the signal may enable the other UE receiving the signal to perform automatic gain control operations, such as adjusting a gain applied to a received signal at a receiver based on one or more properties of the signal (e.g., the received power of the signal).

The UE may identify the duration of data channel (e.g., the symbol location that the data transmission ends) so the UE knows when to stop receiving the data signal. The SCI may indicate whether HARQ feedback transmission for the data channel is enabled, and the UE may determine the data channel duration implicitly or explicitly via the SCI. When SCI indicates that HARQ feedback is enabled, the UE may determine the data channel duration, e.g., based on a (pre)configuration or some pre-determined rule. In response to receiving the SCI, the UE may identify a gap portion and a signal portion within a slot, based on the indication that HARQ feedback is enabled. In certain cases, the SCI may explicitly indicate the duration of the data channel for the data signal. In some such aspects, the SCI further indicates a symbol, the data signal ends during the symbol, and the device performing operations 1100 may determine another symbol, based on the symbol, for the transmission of the feedback signal. That is, the SCI may indicate a symbol where the data signal ends, and the UE may transmit the feedback signal in at least another symbol after the symbol. Expressed another way, the SCI may indicate the duration of the data signal, and the UE may initiate refraining from transmitting based on the duration of the data signal.

In aspects of the present disclosure, the threshold of block 1106 may be one of fixed or configured from a set of candidate values.

According to aspects of the present disclosure, the feedback signal of block 1108 may be transmitted over at least 3 symbols comprising a first symbol in time, a second symbol in time, and a third symbol in time, where the gap portion occurs during the first symbol, the AGC signal is transmitted during the first symbol and the second symbol, and the HARQ feedback is transmitted during the third symbol. In other words, at block 1108, the UE may transmit the feedback signal over at least 3 symbols comprising a first symbol in time, a second symbol in time, and a third symbol in time, where the gap portion occurs during the first symbol. The UE may transmit the signal during the first symbol and the second symbol, and transmit the HARQ feedback during the third symbol.

In aspects of the present disclosure, the feedback signal of block 1108 may be transmitted over at least 2 symbols comprising a first symbol in time and a second symbol in time, where the gap portion occurs during the first symbol, the AGC signal is transmitted during the first symbol, and the HARQ feedback is transmitted during the second symbol. That is, at block 1108, the UE may transmit the feedback signal over at least 2 symbols comprising a first symbol in time and a second symbol in time, where the gap portion occurs during the first symbol. The UE may transmit the signal during the first symbol, and transmit the HARQ feedback during the second symbol.

According to aspects of the present disclosure, the feedback signal of block 1108 may be transmitted over a plurality of symbols comprising a first one or more symbols in time and a second one or more symbols in time, where the gap portion occurs during one of the first one or more symbols, the AGC signal is transmitted during the first one or more symbols, and the HARQ feedback is transmitted during the second one or more symbols. In other words, at block 1108, the UE may transmit the feedback signal over a plurality of symbols comprising a first one or more symbols in time and a second one or more symbols in time, where the gap portion occurs during one of the first one or more symbols. The UE may transmit the signal during the first one or more symbols, and transmit the HARQ feedback during the second one or more symbols.

In aspects of the present disclosure, the AGC signal of block 1108 may include a low-peak-to-average-power-ratio (low-PAPR) sequence.

In aspects, the UE may transmit the feedback signal within the same slot in which the data signal is received. For example, the UE may receive a portion of the data signal in a slot, and the UE may refrain from transmitting during the gap portion in the slot and transmit the feedback signal in the slot.

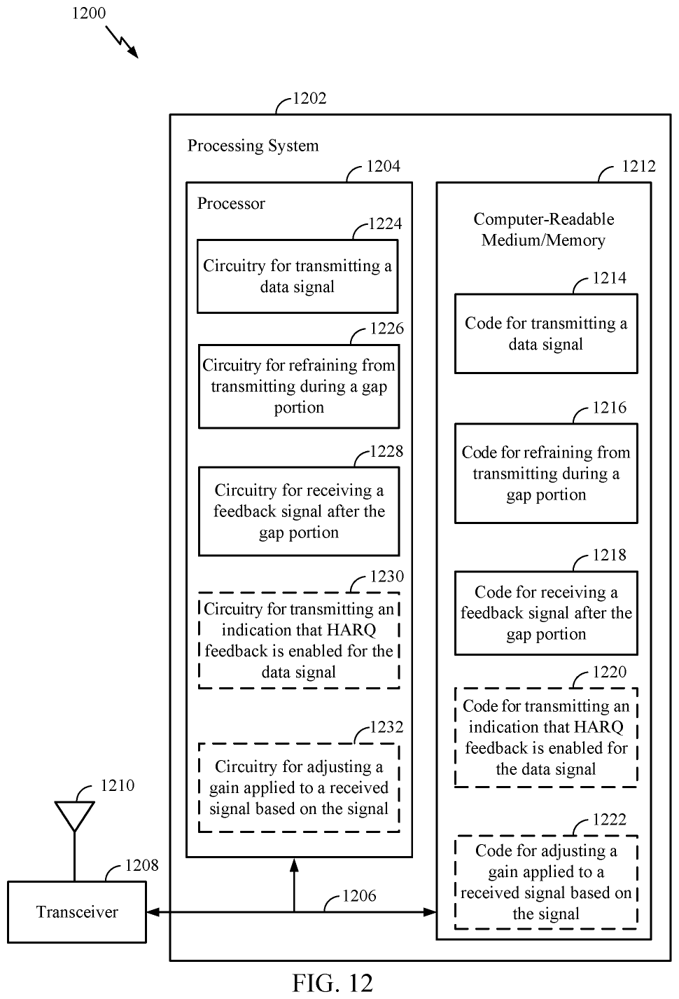

FIG. 12 illustrates a communications device 1200 that may include various components (e.g., corresponding to means-plus-function components) configured to perform operations for the techniques disclosed herein, such as the operations illustrated in FIG. 10. The communications device 1200 includes a processing system 1202 coupled to a transceiver 1208 (e.g., a transmitter and/or a receiver). The transceiver 1208 is configured to transmit and receive signals for the communications device 1200 via an antenna 1210, such as the various signals as described herein. The processing system 1202 may be configured to perform processing functions for the communications device 1200, including processing signals received and/or to be transmitted by the communications device 1200.

The processing system 1202 includes a processor 1204 coupled to a computer-readable medium/memory 1212 via a bus 1206. In certain aspects, the computer-readable medium/memory 1212 is configured to store instructions (e.g., computer-executable code) that when executed by the processor 1204, cause the processor 1204 to perform the operations illustrated in FIG. 10, or other operations for performing the various techniques discussed herein for having a gap portion and an automatic gain control (AGC) portion within one symbol. In certain aspects, computer-readable medium/memory 1212 stores code 1214 for transmitting a data signal; code 1216 for refraining from transmitting during a gap portion occurring in time after the transmission of the data signal, wherein the gap portion has a duration less than or equal to a threshold; code 1218 for receiving a feedback signal after the gap portion, wherein the feedback signal comprises at least an automatic gain control (AGC) signal and hybrid automatic retransmission request (HARQ) feedback for the data signal; code 1220 for transmitting, in SCI, an indication that HARQ feedback is enabled for the data signal; and/or code 1222 for adjusting a gain applied to a received signal at a receiver based on the signal. In certain aspects, the processor 1204 has circuitry configured to implement the code stored in the computer-readable medium/memory 1212. The processor 1204 includes circuitry 1224 for transmitting a data signal; circuitry 1226 for refraining from transmitting during a gap portion occurring in time after the transmission of the data signal, wherein the gap portion has a duration less than or equal to a threshold; circuitry 1228 for receiving a feedback signal after the gap portion, wherein the feedback signal comprises at least an automatic gain control (AGC) signal and hybrid automatic retransmission request (HARQ) feedback for the data signal; circuitry 1230 for transmitting, in SCI, an indication that HARQ feedback is enabled for the data signal; and/or circuitry 1232 for adjusting a gain applied to a received signal at a receiver (e.g., the transceiver 1208) based on the signal.

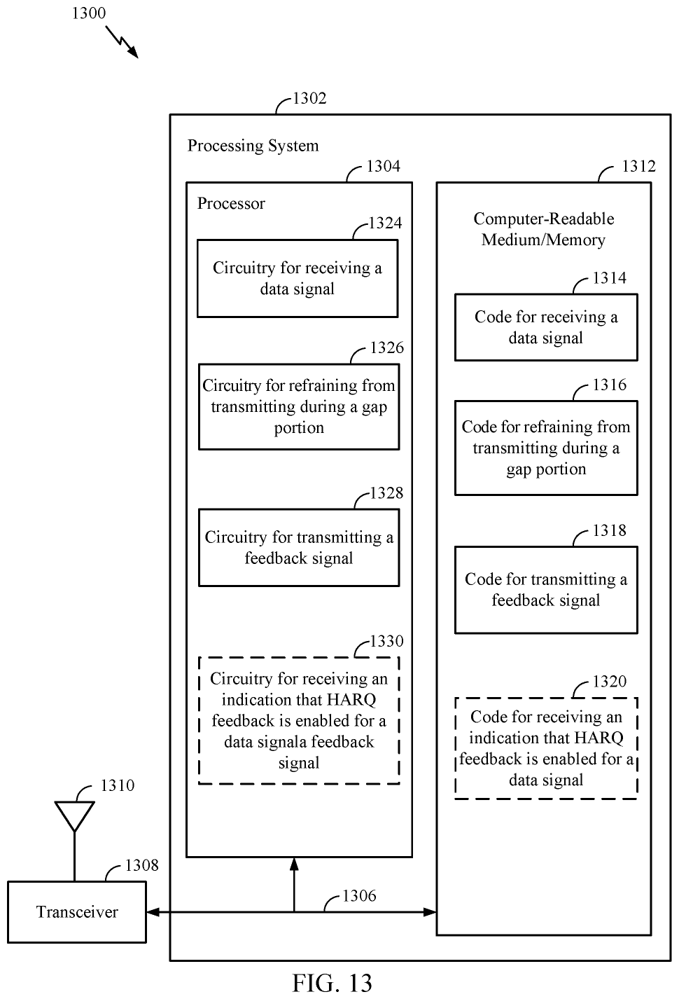

FIG. 13 illustrates a communications device 1300 that may include various components (e.g., corresponding to means-plus-function components) configured to perform operations for the techniques disclosed herein, such as the operations illustrated in FIG. 11. The communications device 1300 includes a processing system 1302 coupled to a transceiver 1308 (e.g., a transmitter and/or a receiver). The transceiver 1308 is configured to transmit and receive signals for the communications device 1300 via an antenna 1310, such as the various signals as described herein. The processing system 1302 may be configured to perform processing functions for the communications device 1300, including processing signals received and/or to be transmitted by the communications device 1300.

The processing system 1302 includes a processor 1304 coupled to a computer-readable medium/memory 1312 via a bus 1306. In certain aspects, the computer-readable medium/memory 1312 is configured to store instructions (e.g., computer-executable code) that when executed by the processor 1304, cause the processor 1304 to perform the operations illustrated in FIG. 11, or other operations for performing the various techniques discussed herein for having a gap portion and an automatic gain control (AGC) portion within one symbol. In certain aspects, computer-readable medium/memory 1312 stores code 1314 for receiving a data signal; code 1316 for refraining from transmitting during a gap portion occurring in time after the receiving of the data signal, wherein the gap portion has a duration less than or equal to a threshold; code 1318 for transmitting a feedback signal that comprises an automatic gain control (AGC) signal and hybrid automatic retransmission request (HARQ) feedback for the data signal; and/or code 1320 for receiving, in SCI, an indication that HARQ feedback is enabled for a data signal. In certain aspects, the processor 1304 has circuitry configured to implement the code stored in the computer-readable medium/memory 1312. The processor 1304 includes circuitry 1324 for receiving a data signal; circuitry 1326 for refraining from transmitting during a gap portion occurring in time after the receiving of the data signal, wherein the gap portion has a duration less than or equal to a threshold; circuitry 1328 for transmitting a feedback signal that comprises an automatic gain control (AGC) signal and hybrid automatic retransmission request (HARQ) feedback for the data signal; and/or circuitry 1330 for receiving, in SCI, an indication that HARQ feedback is enabled for a data signal.

Means for transmitting (or means for outputting for transmission) may include an antenna (e.g., the antennas 252a-252r), a transceiver (e.g., the transceivers 254a-254r), a processor (e.g., the controller/processor 280), and/or circuitry for receiving (e.g., the circuitry for transmitting 1224, 1230, 1328). Means for receiving (or means for obtaining) may include an antenna (e.g., the antennas 252a-252r), a transceiver (e.g., the transceivers 254a-254r), a processor (e.g., the controller/processor 280), and/or circuitry for receiving (e.g., the circuitry for receiving 1228, 1324, 1330). Means for refraining from transmitting may include a transceiver (e.g., the transceivers 254a-254r), a processor (e.g., the controller/processor 280), and/or circuitry for refraining (e.g., the circuitry for refraining 1226, 1326). Means for adjusting may include a transceiver (e.g., the transceivers 254a-254r), a processor (e.g., the controller/processor 280), and/or circuitry for adjusting (e.g., the circuitry for adjusting 1232). In aspects, the various processors and/or various circuitry may include a circuit, a central processing unit (CPU), a graphics processing unit (GPU), a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein.

### Example Aspects

In addition to the various aspects described above, specific combinations of aspects are within the scope of the disclosure, some of which are detailed below:

Aspect 1: A method for wireless communications, comprising: transmitting a data signal; refraining from transmitting during a gap portion occurring in time after the transmission of the data signal, wherein the gap portion has a duration less than or equal to a value; and receiving a feedback signal after the gap portion, wherein the feedback signal comprises at least an automatic gain control (AGC) signal and hybrid automatic retransmission request (HARQ) feedback for the data signal.

Aspect 2: The method of Aspect 1, further comprising: transmitting, in sidelink control information (SCI), an indication that HARQ feedback is enabled for the data signal.

Aspect 3: The method of Aspect 2, wherein the SCI further indicates a symbol, wherein the data signal ends during the symbol, and the method further comprises: determining another symbol, based on the symbol, for the reception of the feedback signal.

Aspect 4: The method of any of Aspects 1-3, wherein the value is one of fixed or configured from a set of candidate values.

Aspect 5: The method of any of Aspects 1-4, wherein the feedback signal is received over at least 3 symbols comprising a first symbol in time, a second symbol in time, and a third symbol in time, wherein the gap portion occurs during the first symbol, the AGC signal is received during the first symbol and the second symbol, and the HARQ feedback is received during the third symbol.

Aspect 6: The method of any of Aspects 1-4, wherein the feedback signal is received over at least 2 symbols comprising a first symbol in time and a second symbol in time, wherein the gap portion occurs during the first symbol, the AGC signal is received during the first symbol, and the HARQ feedback is received during the second symbol.

Aspect 7: The method of any of Aspects 1-4, wherein the feedback signal is received over a plurality of symbols comprising a first one or more symbols in time and a second one or more symbols in time, wherein the gap portion occurs during one of the first one or more symbols, the AGC signal is received during the first one or more symbols, and the HARQ feedback is received during the second one or more symbols.

Aspect 8: A method for wireless communications, comprising: receiving a data signal; refraining from transmitting during a gap portion occurring in time after the receiving of the data signal, wherein the gap portion has a duration less than or equal to a value; and transmitting a feedback signal that comprises an automatic gain control (AGC) signal and hybrid automatic retransmission request (HARQ) feedback for the data signal.

Aspect 9: The method of Aspect 8, further comprising: receiving, in sidelink control information (SCI), an indication that HARQ feedback is enabled for the data signal.

Aspect 10: The method of Aspect 9, wherein the SCI further indicates a symbol, wherein the data signal ends during the symbol, and the method further comprises: determining another symbol, based on the symbol, for the transmission of the feedback signal.

Aspect 11: The method of any of Aspects 8-10, wherein the value is one of fixed or configured from a set of candidate values.

Aspect 12: The method of any of Aspects 8-11, wherein the feedback signal is transmitted over at least 3 symbols comprising a first symbol in time, a second symbol in time, and a third symbol in time, wherein the gap portion occurs during the first symbol, the AGC signal is transmitted during the first symbol and the second symbol, and the HARQ feedback is transmitted during the third symbol.

Aspect 13: The method of any of Aspects 8-11, wherein the feedback signal is transmitted over at least 2 symbols comprising a first symbol in time and a second symbol in time, wherein the gap portion occurs during the first symbol, the AGC signal is transmitted during the first symbol, and the HARQ feedback is transmitted during the second symbol.

Aspect 14: The method of any of Aspects 8-11, wherein the feedback signal is transmitted over a plurality of symbols comprising a first one or more symbols in time and a second one or more symbols in time, wherein the gap portion occurs during one of the first one or more symbols, the AGC signal is transmitted during the first one or more symbols, and the HARQ feedback is transmitted during the second one or more symbols.

Aspect 15: The method of any of Aspects 8-14, wherein the AGC signal comprises a low-peak-to-average-power-ratio (low-PAPR) sequence.

Aspect 16: An apparatus for wireless communications, comprising means for performing a method in accordance with any one of Aspects 1-15 or 35-48.

Aspect 17: An apparatus for wireless communications, comprising: a memory; and a processor coupled to the memory, the memory and the processor configured to perform a method in accordance with any one of Aspects 1-15 or 35-48.

Aspect 18: A computer-readable medium, the medium including instructions that, when executed by a processing system, cause the processing system to perform a method in accordance with any one of Aspects 1-15 or 35-48.

Aspect 19: An apparatus for wireless communications, comprising: a memory; and a processor coupled to the memory, the processor and the memory being configured to: transmit a data signal, and refrain from transmitting during a gap portion occurring in time after the transmission of the data signal, wherein the gap portion has a duration in time less than or equal to a threshold, receive a feedback signal after the gap portion, wherein the feedback signal comprises at least a signal and hybrid automatic retransmission request (HARQ) feedback for the data signal, receive another signal, and adjust a gain applied to the other signal based on the signal.

Aspect 20: The apparatus of Aspect 19, wherein the processor and the memory are further configured to transmit, in sidelink control information (SCI), an indication that HARQ feedback is enabled for the data signal.

Aspect 21: The apparatus of Aspect 20, wherein: the SCI further indicates a duration in time of the data signal; and the processor and the memory are configured to initiate refraining from transmitting at a time based on the duration of the data signal.

Aspect 22: The apparatus according to any one of Aspects 19-21, wherein the threshold is one of fixed or configured from a set of candidate values.

Aspect 23: The apparatus according to any one of Aspects 19-22, wherein the processor and the memory are configured to: receive the feedback signal over at least 3 symbols comprising a first symbol in time, a second symbol in time, and a third symbol in time, wherein the gap portion occurs during the first symbol, and receive the signal during the first symbol and the second symbol, and receive the HARQ feedback during the third symbol.

Aspect 24: The apparatus according to any one of Aspects 19-22, wherein the processor and the memory are configured to: receive the feedback signal over at least 2 symbols comprising a first symbol in time and a second symbol in time, wherein the gap portion occurs during the first symbol, and receive the signal during the first symbol, and receive the HARQ feedback during the second symbol.

Aspect 25: The apparatus according to any one of Aspects 19-22, wherein the processor and the memory are configured to: receive the feedback signal over a plurality of symbols comprising a first one or more symbols in time and a second one or more symbols in time, wherein the gap portion occurs during one of the first one or more symbols, and receive the signal during the first one or more symbols, and receive the HARQ feedback during the second one or more symbols.

Aspect 26: The apparatus according to any one of Aspects 19-25, wherein the processor and the memory are configured to: transmit at least a portion of the data signal in a slot and refrain from transmitting during the gap portion in the slot; and receive the feedback signal in the slot.

Aspect 27: An apparatus for wireless communications, comprising: a memory; a processor coupled to the memory, the processor and the memory being configured to: receive, in sidelink control information (SCI), an indication that hybrid automatic retransmission request (HARQ) feedback is enabled for a data signal, receive the data signal, refrain from transmitting during a gap portion occurring in time after the receiving of the data signal, wherein the gap portion has a duration in time less than or equal to a threshold, and transmit, after the gap portion, a feedback signal that comprises a signal and HARQ feedback for the data signal.

Aspect 28: The apparatus of Aspect 27, wherein: the SCI further indicates a duration in time of the data signal; and the processor and the memory are configured to initiate refraining from transmitting at a time based on the duration of the data signal.

Aspect 29: The apparatus according to any one of Aspects 27 or 28, wherein the threshold is one of fixed or configured from a set of candidate values.

Aspect 30: The apparatus according to any one of Aspects 27-29, wherein the processor and the memory are configured to transmit the feedback signal over at least 3 symbols comprising a first symbol in time, a second symbol in time, and a third symbol in time, wherein the gap portion occurs during the first symbol, and wherein the processor and the memory are configured to transmit the signal during the first symbol and the second symbol, and transmit the HARQ feedback during the third symbol.

Aspect 31: The apparatus according to any one of Aspects 27-29, wherein the processor and the memory are configured to transmit the feedback signal over at least 2 symbols comprising a first symbol in time and a second symbol in time, wherein the gap portion occurs during the first symbol, and wherein the processor and the memory are configured to transmit the signal during the first symbol, and transmit the HARQ feedback during the second symbol.

Aspect 32: The apparatus of Aspect 27, wherein the processor and the memory are configured to transmit the feedback signal over a plurality of symbols comprising a first one or more symbols in time and a second one or more symbols in time, wherein the gap portion occurs during one of the first one or more symbols, and wherein the processor and the memory are configured to transmit the signal during the first one or more symbols, and transmit the HARQ feedback during the second one or more symbols.

Aspect 33: The apparatus of Aspect 27, wherein the signal comprises a low-peak-to-average-power-ratio (low-PAPR) sequence.

Aspect 34: The apparatus of Aspect 27, wherein: the processor and the memory are configured to receive a portion of the data signal in a slot, and refrain from transmitting during the gap portion in the slot and transmit the feedback signal in the slot; and the signal is an automatic gain control (AGC) signal.

Aspect 35: A method for wireless communications, comprising: transmitting a data signal; refraining from transmitting during a gap portion occurring in time after the transmission of the data signal, wherein the gap portion has a duration less than or equal to a threshold; receiving a feedback signal after the gap portion, wherein the feedback signal comprises at least a signal and hybrid automatic retransmission request (HARQ) feedback for the data signal; receiving another signal; adjusting a gain applied to the other signal based on the signal.

Aspect 36: The method of Aspect 35, further comprising: transmitting, in sidelink control information (SCI), an indication that HARQ feedback is enabled for the data signal.

Aspect 37: The method of Aspect 36, wherein: the SCI further indicates a duration of the data signal, and refraining from transmitting comprises initiating refraining from transmitting based on the duration of the data signal.

Aspect 38: The method according to any one of Aspects 35-37, wherein the threshold is one of fixed or configured from a set of candidate values.

Aspect 39: The method according to any one of Aspects 35-38, wherein: receiving the feedback signal comprises receiving the feedback signal over at least 3 symbols comprising a first symbol in time, a second symbol in time, and a third symbol in time, wherein the gap portion occurs during the first symbol; and receiving the feedback signal further comprises receiving the signal during the first symbol and the second symbol, and receiving the HARQ feedback during the third symbol.

Aspect 40: The method according to any one of Aspects 35-38, wherein: receiving the feedback signal comprises receiving the feedback signal over at least 2 symbols comprising a first symbol in time and a second symbol in time, wherein the gap portion occurs during the first symbol, receiving the feedback signal further comprises receiving the signal during the first symbol, and receiving the HARQ feedback during the second symbol.

Aspect 41: The method according to any one of Aspects 35-38, wherein: receiving the feedback signal comprises receiving the feedback signal over a plurality of symbols comprising a first one or more symbols in time and a second one or more symbols in time, wherein the gap portion occurs during one of the first one or more symbols, receiving the feedback signal further comprises receiving the signal during the first one or more symbols, and receiving the HARQ feedback during the second one or more symbols.

Aspect 42: A method for wireless communications, comprising: receiving, in sidelink control information (SCI), an indication that hybrid automatic retransmission request (HARQ) feedback is enabled for a data signal; receiving the data signal; refraining from transmitting during a gap portion occurring in time after the receiving of the data signal, wherein the gap portion has a duration less than or equal to a threshold; and transmitting a feedback signal that comprises a signal and HARQ feedback for the data signal.

Aspect 43: The method of Aspect 42, wherein: the SCI further indicates a symbol where the data signal ends, and the method further comprises transmitting the feedback signal in at least another symbol after the symbol.

Aspect 44: The method according to any one of Aspects 42 or 43, wherein the threshold is one of fixed or configured from a set of candidate values.

Aspect 45: The method according to any one of Aspects 42-44, wherein: transmitting the feedback signal comprises transmitting the feedback signal over at least 3 symbols comprising a first symbol in time, a second symbol in time, and a third symbol in time, wherein the gap portion occurs during the first symbol; and transmitting the feedback signal further comprises transmitting the signal during the first symbol and the second symbol, and transmitting the HARQ feedback during the third symbol.

Aspect 46: The method according to any one of Aspects 42-44, wherein: transmitting the feedback signal comprises transmitting the feedback signal over at least 2 symbols comprising a first symbol in time and a second symbol in time, wherein the gap portion occurs during the first symbol; and transmitting the feedback signal further comprises transmitting the signal during the first symbol, and transmitting the HARQ feedback during the second symbol.

Aspect 47: The method according to any one of Aspects 42-44, wherein: transmitting the feedback signal comprises transmitting the feedback signal over a plurality of symbols comprising a first one or more symbols in time and a second one or more symbols in time, wherein the gap portion occurs during one of the first one or more symbols; and transmitting the feedback signal further comprises transmitting the signal during the first one or more symbols, and transmitting the HARQ feedback during the second one or more symbols.

Aspect 48: The method according to any one of Aspects 42-47, wherein the signal comprises a low-peak-to-average-power-ratio (low-PAPR) sequence.

### Additional Considerations

The techniques described herein may be used for various wireless communication technologies, such as NR (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a Customer Premises Equipment (CPE), a cellular phone, a smart phone, a personal digital assistant (PDA), a wireless modem, a wireless communication device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wrist band, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within its service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user terminal (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 10 and/or FIG. 11.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

1. An apparatus for wireless communications, comprising:
a memory; and
a processor coupled to the memory, the processor and the memory being configured to:
transmit a data signal, and
refrain from transmitting during a gap portion occurring in time after the transmission of the data signal, wherein the gap portion has a duration in time less than or equal to a threshold,
receive a feedback signal after the gap portion, wherein the feedback signal comprises at least a signal and hybrid automatic retransmission request (HARQ) feedback for the data signal,
receive another signal, and
adjust a gain applied to the other signal based on the signal.

2. The apparatus of claim 1, wherein the processor and the memory are further configured to transmit, in sidelink control information (SCI), an indication that HARQ feedback is enabled for the data signal.

3. The apparatus of claim 2, wherein:
the SCI further indicates a duration in time of the data signal; and
the processor and the memory are configured to initiate refraining from transmitting at a time based on the duration of the data signal.

4. The apparatus of claim 1, wherein the threshold is one of fixed or configured from a set of candidate values.

5. The apparatus of claim 1, wherein the processor and the memory are configured to:
receive the feedback signal over at least 3 symbols comprising a first symbol in time, a second symbol in time, and a third symbol in time, wherein the gap portion occurs during the first symbol, and
receive the signal during the first symbol and the second symbol, and receive the HARQ feedback during the third symbol.

6. The apparatus of claim 1, wherein the processor and the memory are configured to:
receive the feedback signal over at least 2 symbols comprising a first symbol in time and a second symbol in time, wherein the gap portion occurs during the first symbol, and
receive the signal during the first symbol, and receive the HARQ feedback during the second symbol.

7. The apparatus of claim 1, wherein the processor and the memory are configured to:
receive the feedback signal over a plurality of symbols comprising a first one or more symbols in time and a second one or more symbols in time, wherein the gap portion occurs during one of the first one or more symbols, and
receive the signal during the first one or more symbols, and receive the HARQ feedback during the second one or more symbols.

8. The apparatus of claim 1, wherein the processor and the memory are configured to:
transmit at least a portion of the data signal in a slot and refrain from transmitting during the gap portion in the slot; and
receive the feedback signal in the slot.

9. An apparatus for wireless communications, comprising:
a memory; and
a processor coupled to the memory, the processor and the memory being configured to:
receive, in sidelink control information (SCI), an indication that hybrid automatic retransmission request (HARQ) feedback is enabled for a data signal,
receive the data signal,
refrain from transmitting during a gap portion occurring in time after the receiving of the data signal, wherein the gap portion has a duration in time less than or equal to a threshold, and
transmit, after the gap portion, a feedback signal that comprises a signal and HARQ feedback for the data signal.

10. The apparatus of claim 9, wherein:
the SCI further indicates a duration in time of the data signal; and
the processor and the memory are configured to initiate refraining from transmitting at a time based on the duration of the data signal.

11. The apparatus of claim 9, wherein the threshold is one of fixed or configured from a set of candidate values.

12. The apparatus of claim 9, wherein the processor and the memory are configured to transmit the feedback signal over at least 3 symbols comprising a first symbol in time, a second symbol in time, and a third symbol in time, wherein the gap portion occurs during the first symbol, and wherein the processor and the memory are configured to transmit the signal during the first symbol and the second symbol, and transmit the HARQ feedback during the third symbol.

13. The apparatus of claim 9, wherein the processor and the memory are configured to transmit the feedback signal over at least 2 symbols comprising a first symbol in time and a second symbol in time, wherein the gap portion occurs during the first symbol, and wherein the processor and the memory are configured to transmit the signal during the first symbol, and transmit the HARQ feedback during the second symbol.

14. The apparatus of claim 9, wherein the processor and the memory are configured to transmit the feedback signal over a plurality of symbols comprising a first one or more symbols in time and a second one or more symbols in time, wherein the gap portion occurs during one of the first one or more symbols, and wherein the processor and the memory are configured to transmit the signal during the first one or more symbols, and transmit the HARQ feedback during the second one or more symbols.

15. The apparatus of claim 9, wherein the signal comprises a low-peak-to-average-power-ratio (low-PAPR) sequence.

16. The apparatus of claim 9, wherein:
the processor and the memory are configured to receive a portion of the data signal in a slot, and refrain from transmitting during the gap portion in the slot and transmit the feedback signal in the slot; and
the signal is an automatic gain control (AGC) signal.

17. A method for wireless communications, comprising:
transmitting a data signal;
refraining from transmitting during a gap portion occurring in time after the transmission of the data signal, wherein the gap portion has a duration less than or equal to a threshold;
receiving a feedback signal after the gap portion, wherein the feedback signal comprises at least a signal and hybrid automatic retransmission request (HARQ) feedback for the data signal;
receiving another signal; and
adjusting a gain applied to the other signal based on the signal.

18. The method of claim 17, further comprising:
transmitting, in sidelink control information (SCI), an indication that HARQ feedback is enabled for the data signal.

19. The method of claim 18, wherein:
the SCI further indicates a duration of the data signal, and
refraining from transmitting comprises initiating refraining from transmitting based on the duration of the data signal.

20. The method of claim 17, wherein the threshold is one of fixed or configured from a set of candidate values.

21. The method of claim 17, wherein:
receiving the feedback signal comprises receiving the feedback signal over at least 3 symbols comprising a first symbol in time, a second symbol in time, and a third symbol in time, wherein the gap portion occurs during the first symbol; and
receiving the feedback signal further comprises receiving the signal during the first symbol and the second symbol, and receiving the HARQ feedback during the third symbol.

22. The method of claim 17, wherein:
receiving the feedback signal comprises receiving the feedback signal over at least 2 symbols comprising a first symbol in time and a second symbol in time, wherein the gap portion occurs during the first symbol,
receiving the feedback signal further comprises receiving the signal during the first symbol, and receiving the HARQ feedback during the second symbol.

23. The method of claim 17, wherein:
receiving the feedback signal comprises receiving the feedback signal over a plurality of symbols comprising a first one or more symbols in time and a second one or more symbols in time, wherein the gap portion occurs during one of the first one or more symbols,
receiving the feedback signal further comprises receiving the signal during the first one or more symbols, and receiving the HARQ feedback during the second one or more symbols.

24. A method for wireless communications, comprising:
receiving, in sidelink control information (SCI), an indication that hybrid automatic retransmission request (HARQ) feedback is enabled for a data signal;
receiving the data signal;
refraining from transmitting during a gap portion occurring in time after the receiving of the data signal, wherein the gap portion has a duration less than or equal to a threshold; and
transmitting a feedback signal that comprises a signal and HARQ feedback for the data signal.

25. The method of claim 24, wherein:
the SCI further indicates a symbol where the data signal ends, and
the method further comprises transmitting the feedback signal in at least another symbol after the symbol.

26. The method of claim 24, wherein the threshold is one of fixed or configured from a set of candidate values.

27. The method of claim 24, wherein:
transmitting the feedback signal comprises transmitting the feedback signal over at least 3 symbols comprising a first symbol in time, a second symbol in time, and a third symbol in time, wherein the gap portion occurs during the first symbol; and
transmitting the feedback signal further comprises transmitting the signal during the first symbol and the second symbol, and transmitting the HARQ feedback during the third symbol.

28. The method of claim 24, wherein:
transmitting the feedback signal comprises transmitting the feedback signal over at least 2 symbols comprising a first symbol in time and a second symbol in time, wherein the gap portion occurs during the first symbol; and
transmitting the feedback signal further comprises transmitting the signal during the first symbol, and transmitting the HARQ feedback during the second symbol.

29. The method of claim 24, wherein:
transmitting the feedback signal comprises transmitting the feedback signal over a plurality of symbols comprising a first one or more symbols in time and a second one or more symbols in time, wherein the gap portion occurs during one of the first one or more symbols; and
transmitting the feedback signal further comprises transmitting the signal during the first one or more symbols, and transmitting the HARQ feedback during the second one or more symbols.

30. The method of claim 24, wherein the signal comprises a low-peak-to-average-power-ratio (low-PAPR) sequence.
